(19) United States
(12) Patent Application Publication
(10) Pub. No.: US 2024/0418201 A1
(43) Pub. Date: Dec. 19, 2024

(54) TELESCOPE SYSTEM AND METHOD

(71) Applicants: James Alan Monroe, Syracuse, NY (US); Jeremy Sean McAllister, New York, NY (US); Jay Russell Zgarba, Sugar Land, TX (US)

(72) Inventors: James Alan Monroe, Syracuse, NY (US); Jeremy Sean McAllister, New York, NY (US); Jay Russell Zgarba, Sugar Land, TX (US)

(21) Appl. No.: 18/814,487

(22) Filed: Aug. 24, 2024

Related U.S. Application Data
(63) Continuation-in-part of application No. 17/981,406, filed on Nov. 5, 2022, now Pat. No. 12,071,969.
(63) Continuation-in-part of application No. 17/981,407, filed on Nov. 5, 2022, now Pat. No. 12,071,970.
Application No. 16/735,587 is a continuation-in-part of application No. 15/963,428, filed on Apr. 26, 2018, now Pat. No. 11,125,966.
Application No. 15/963,428 is a continuation-in-part of application No. 15/217,594, filed on Jul. 22, 2016, now Pat. No. 10,822,670.
Application No. 15/217,594 is a continuation-in-part of application No. 14/897,904, filed on Dec. 11, 2015, now Pat. No. 10,557,182.
(60) Provisional application No. 62/490,877, filed on Apr. 27, 2017.
(60) Provisional application No. 61/835,289, filed on Jun. 14, 2013.

(51) Int. Cl. F16B 31/04; C21D 7/00; C22F 1/18; F16B 31/00; F16B 31/06; F16B 43/00

(52) U.S. Cl. CPC F16B 31/04; C22F 1/183; F16B 31/007; F16B 31/06; F16B 43/001; C21D 7/00

(57) ABSTRACT

A series tailored athermally stabilized optical (STASO) telescope system (STASOS) and method (STASOM) is disclosed. The disclosed system/method separates an optical mirror source (OMS) and an optical focal target (OFT) via a first metering rod (FMR), second metering rod (SMR), and third metering rod (TMR) where the FMR, SMR, and TMR each comprise a first retaining rod (FRR) comprised of a material having a first thermal expansion (FTE) coefficient and a second retaining rod (SRR) comprised of a material having a second thermal expansion (STE) coefficient. The FMR, SMR, and TMR are constructed so as to be athermally stabilized to ensure that the OMS and OFT remain separated at a constant or controlled distance over a predetermined temperature range by selection of appropriate FTE and STE coefficients.

### CROSS REFERENCE TO RELATED APPLICATIONS

### Continuation-In-Part Patent Application

This patent application is a Continuation-In-Part patent application (CIP) and incorporates by reference United States Utility patent application for THERMALLY STABILIZED FASTENER SYSTEM AND METHOD by inventors James Alan Monroe, Jeremy Sean McAllister, and Jay Russell Zgarba, filed with the USPTO on 2022 Nov. 5, with Ser. No. 17/981,406, EFS ID 46967901, confirmation number 5389, docket AZTES.0104DIV4, issued as U.S. Pat. No. 12,071,969 on 2024 Aug. 27.

This patent application is a Continuation-In-Part patent application (CIP) and incorporates by reference United States Utility patent application for THERMALLY STABILIZED FASTENER SYSTEM AND METHOD by inventors James Alan Monroe, Jeremy Sean McAllister, and Jay Russell Zgarba, filed with the USPTO on 2022 Nov. 5, with Ser. No. 17/981,407, EFS ID 46967904, confirmation number 9791, docket AZTES.0104DIV5, issued as U.S. Pat. No. 12,071,970 on 2024 Aug. 27.

### Divisional Patent Application

United States Utility patent application for THERMALLY STABILIZED FASTENER SYSTEM AND METHOD by inventors James Alan Monroe, Jeremy Sean McAllister, and Jay Russell Zgarba, filed with the USPTO on 2022 Nov. 5, with Ser. No. 17/981,407, EFS ID 46967904, confirmation number 9791, docket AZTES.0104DIV5, issued as U.S. Pat. No. 12,071,970 on 2024 Aug. 27 is a Divisional patent application (DIV) and incorporates by reference United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22.

United States Utility patent application for THERMALLY STABILIZED FASTENER SYSTEM AND METHOD by inventors James Alan Monroe, Jeremy Sean McAllister, and Jay Russell Zgarba, filed with the USPTO on 2022 Nov. 5, with Ser. No. 17/981,406, EFS ID 46967901, confirmation number 5389, docket AZTES.0104DIV4, issued as U.S. Pat. No. 12,071,969 on 2024 Aug. 27 is a Divisional patent application (DIV) and incorporates by reference United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22.

### U.S. Patent Applications

United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22 is a Continuation-In-Part (CIP) and incorporates by reference United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation number 5258, docket TAMUS 3809 CIP, issued as U.S. patent Ser. No. 10/822,670 on 2020 Nov. 3.

United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation number 5258, docket TAMUS 3809 CIP, issued as U.S. patent Ser. No. 10/822,670 on 2020 Nov. 3 is a Continuation-In-Part (CIP) patent application of and incorporates by reference United States Utility patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Dec. 11, 2015, with Ser. No. 14/897,904, published on May 12, 2016 as US20160130677A1, issued as U.S. Pat. No. 10,557,182 on 2020 Feb. 11.

United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022-11-22, claims benefit under 35 U.S.C. § 120 and incorporates by reference United States Utility patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Dec. 11, 2015, with Ser. No. 14/897,904, published on May 12, 2016 as US20160130677A1, issued as U.S. Pat. No. 10,557,182 on 2020-02-11.

United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022 Nov. 22, claims benefit under 35 U.S.C. § 120 and incorporates by reference United States Utility patent application for LENS ALIGNMENT SYSTEM AND METHOD by inventors James Alan Monroe, David Scott Content, Jeremy Sean McAllister, and Jay Russell Zgarba, filed with the USPTO on Apr. 26, 2018, with Ser. No. 15/963,428, EFSID 32454176, confirmation number 1064, docket AZTES.0103, issued as U.S. Pat. No. 11,125,966 on 2021 Sep. 21.

This application claims benefit under 35 U.S.C. § 120 and incorporates by reference United States Utility patent application for THERMALLY STABILIZED FASTENER SYSTEM AND METHOD by inventors James Alan Monroe, Jeremy Sean McAllister, and Jay Russell Zgarba, filed with the USPTO on Jan. 6, 2020, with Ser. No. 16/735,587, EFS ID 38218309, confirmation number 5182, docket AZTES.0104, issued as U.S. Pat. No. 11,506,238 on 2022-11-22.

United States Utility patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Dec. 11, 2015, with Ser. No. 14/897,904, and published on May 12, 2016 as US20160130677A1, issued as U.S. Pat. No. 10,557,182 on 2020 Feb. 11, is a national stage United States Utility patent application of and incorporates by reference PCT patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Jun. 12, 2014, with serial number PCT/US2014/042105, and published on Dec. 18, 2014 as WO2014201239A2.

United States Utility patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Dec. 11, 2015, with Ser. No. 14/897,904, published on May 12, 2016 as US20160130677A1, issued as U.S. Pat. No. 10,557,182 on 2020 Feb. 11, claims benefit under 35 U.S.C. § 120 and incorporates by reference PCT patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Jun. 12, 2014, with serial number PCT/US2014/042105, and published on Dec. 18, 2014 as WO2014201239A2.

### Provisional Patent Applications

PCT Patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Jun. 12, 2014, with serial number PCT/US2014/042105, and published on Dec. 18, 2014 as WO2014201239A2 claims benefit under 35 U.S.C. § 119 and incorporates by reference United States Provisional patent application for SYSTEMS AND METHODS FOR TAILORING COEFFICIENTS OF THERMAL EXPANSION BETWEEN EXTREME POSITIVE AND EXTREME NEGATIVE VALUES by inventors James A. Monroe, Ibrahim Karaman, and Raymundo Arroyave, filed with the USPTO on Jun. 14, 2013, with Ser. No. 61/835,289.

United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation number 5258, docket TAMUS 3809 CIP, issued as U.S. patent Ser. No. 10/822,670 on 2020 Nov. 3, claims benefit under 35 U.S.C. § 119 and incorporates by reference United States Provisional patent application for CONTROLLED THERMAL COEFFICIENT PRODUCT SYSTEM AND METHOD by inventor James A. Monroe, filed with the USPTO on Jul. 22, 2015, with Ser. No. 62/195,575, EFS ID 22993562, confirmation number 5403, docket AZTES.0101P.

United States Utility patent application for LENS ALIGNMENT SYSTEM AND METHOD by inventors James Alan Monroe, David Scott Content, Jeremy Sean McAllister, and Jay Russell Zgarba, filed with the USPTO on Apr. 26, 2018, with Ser. No. 15/963,428, EFSID 32454176, confirmation number 1064, docket AZTES.0103, issued as U.S. Pat. No. 11,125,966 on 2021 Sep. 21 claims benefit under 35 U.S.C. § 119 and incorporates by reference United States Provisional patent application for THERMALLY STABILIZED FASTENER SYSTEM AND METHOD by inventors James Alan Monroe, David Scott Content, Jeremy Sean McAllister, and Jay Russell Zgarba, filed with the USPTO on Apr. 27, 2017, with EFSID 29050356, Ser. No. 62/490,877, confirmation number 8425, docket

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates to telescope systems and methods that are thermally stabilized (“athermalized”) over a wide temperature range. Without limitation, the present invention may be applied to situations where a plurality of components in a telescope system must be constructed in a manner so as to maintain constant distances, tensions, or compressions along a common optical axis (COA).

PRIOR ART AND BACKGROUND OF THE INVENTION Typical telescope systems and methods incorporate one or more mirrors and/or lenses (OML) in conjunction with an optical focal target (OFT) such that light is processed by the OML and presented to the OFT as an image for processing and/or analysis. The OML and OFT are retained by a variety of optical separation hardware (OSH) to stabilize the optical focal distance (OFD) between the OML and OFT such that the focal distance between these entities is maintained to ensure a sharp image on the OFT.

However, the OSH typically has a coefficient of thermal expansion (CTE) associated with its overall construction, as it is conventionally constructed of metal to support the significant mass of the OML and/or OFT. This CTE modulates the OFD due to variations in temperature in which the telescope system operates. This modulation in OFD results in undesirable blurring of the image presented to the OFT.

While many exotic methodologies have been proposed to athermally stabilize the OSH and eliminate the OFD modulation over temperature, no simple solution to this problem has been found within the optical arts.

### Long-Felt Industry Need for Thermally Stabilized Telescopes

All metals expand when hot and contract when cold. The positive thermal coefficient experienced by most metals can have a huge impact on telescope applications that see deterioration in the performance, efficiency, and safety of their products due to severe temperature swings and/or vibration. For example, when cooled, aluminum shrinks significantly while a steel bolt shrinks to a lesser extent and as such a fastener joining these materials will loosen with decreasing temperature. When the same joint is heated, the aluminum expands more than the steel bolt and the joint can become over tight stretching or even breaking the bolt. This loosening during thermal cycling and vibration cause fatigue and bolt failure, a long standing major problem in the construction of OML and OFT support/separation structures in telescopes.

The present invention teaches the use of thermally compensating members (TCM) such as tubes, cylinders, and other metallic forms to completely change the way engineers attack the thermal expansion problem of the OFD in telescopes. Using a simple temperature compensating metal tube/cylinder that expands when cooled can take up the slack in an OFD and stabilize the OFD over temperature. By reacting opposite to other metals, it can keep the focal distance between the OML and OFT constant over severe temperature swings in space, and maintain constant load on cryogenic assemblies found in multiple processing environments like liquefied natural gas (LNG) and scientific research labs.

### Deficiencies in the Prior Art

Prior art thermally stabilized telescope systems typically suffer from the following characteristic deficiencies:
Prior thermally stabilized telescope systems have a coefficient of thermal expansion (CTE) that cannot accurately be controlled.
Prior thermally stabilized telescope systems have a coefficient of thermal expansion (CTE) that cannot be controlled across one or more axes of expansion.
Prior thermally stabilized telescope systems have a coefficient of thermal expansion (CTE) that cannot be tailored to provide a customized expansion coefficient across one or more axes of expansion.
Prior thermally stabilized telescope systems have a coefficient of thermal expansion (CTE) that cannot be tailored to provide a customized OFD with temperature changes across one or more axes of expansion.
Prior thermally stabilized telescope systems cannot provide a zero coefficient of thermal expansion (CTE) over one or more axes of expansion.
Prior thermally stabilized telescope systems cannot provide a negative coefficient of thermal expansion (CTE) over one or more axes of expansion.

To date the prior art has not fully addressed these deficiencies.

### OBJECTIVES OF THE INVENTION

Accordingly, the objectives of the present invention are (among others) to circumvent the deficiencies in the prior art and affect the following objectives:
(1) Provide for a thermally stabilized telescope system/method for producing same that have a coefficient of thermal expansion (CTE) that can accurately be controlled.
(2) Provide for a thermally stabilized telescope system/method for producing same in which the coefficient of thermal expansion (CTE) can be controlled across one or more axes of expansion.
(3) Provide for a thermally stabilized telescope system/method for producing same in which the coefficient of thermal expansion (CTE) can be tailored to provide a customized expansion coefficient across one or more axes of expansion.
(4) Provide for a thermally stabilized telescope system/method for producing the same in which the coefficient of thermal expansion (CTE) can be tailored to provide a customized OFD with temperature changes across one or more axes of expansion.
(5) Provide for a thermally stabilized telescope system/method for producing same that can produce a zero coefficient of thermal expansion (CTE) across one or more axes of expansion.
(6) Provide for a thermally stabilized telescope system/method for producing same that can produce a negative coefficient of thermal expansion (CTE) across one or more axes of expansion.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

While all metals expand when hot and contract when cold, the recent development of tailored thermal expansion coefficient (TEC) materials allows the creation of metallic materials that do the opposite: they contract when heated and expand when cooled. This brand-new material property enables the creation of tubular separators that compensate for the natural expansion and contraction of other materials being separated and thus the creation of thermally stabilized telescopes as described herein.

The present invention generally addresses the need for thermally stabilized telescope systems having a known coefficient of thermal expansion (CTE) in the following manner. The disclosed system/method separates an optical mirror source (OMS) and an optical focal target (OFT) via a series connection of a first metering tube (FMT) and a second metering tube (SMT) that have been selected to have complementary thermal expansion characteristics so as to keep the OMS and OFT at a predetermined distance from one another. In this manner the OFD associated with the OMS and OFT is maintained at a constant distance over a wide temperature range.

Details regarding the tailored CTE metallic material product (MMP) is disclosed within United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation number 5258, docket TAMUS 3809 CIP, and other patents/patent applications incorporated herein.

### BRIEF DESCRIPTION OF THE DRAWINGS

For a fuller understanding of the advantages provided by the invention, reference should be made to the following detailed description together with the accompanying drawings wherein:

FIG. 1 illustrates a system block assembly diagram describing a preferred exemplary system embodiment of the present invention;

FIG. 2 illustrates a flowchart illustrating a preferred exemplary method embodiment of the present invention;

FIG. 3 illustrates a front view of a preferred exemplary invention embodiment;

FIG. 4 illustrates a rear view of a preferred exemplary invention embodiment;

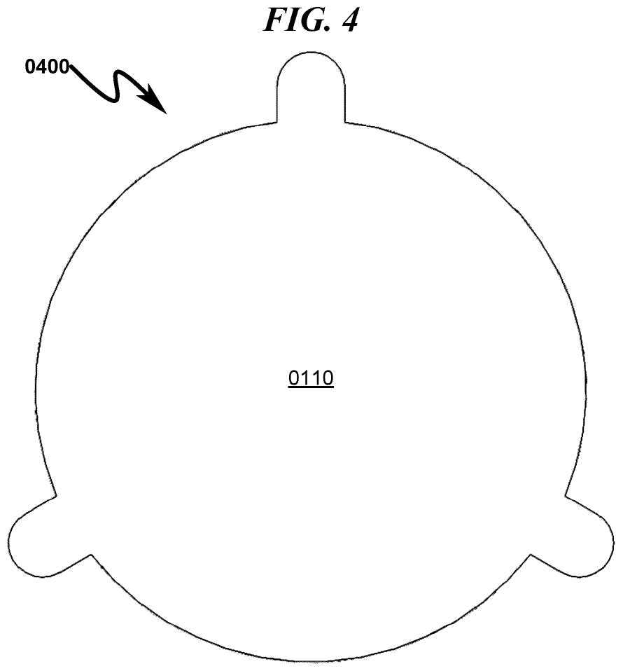

FIG. 5 illustrates a left side view of a preferred exemplary invention embodiment;

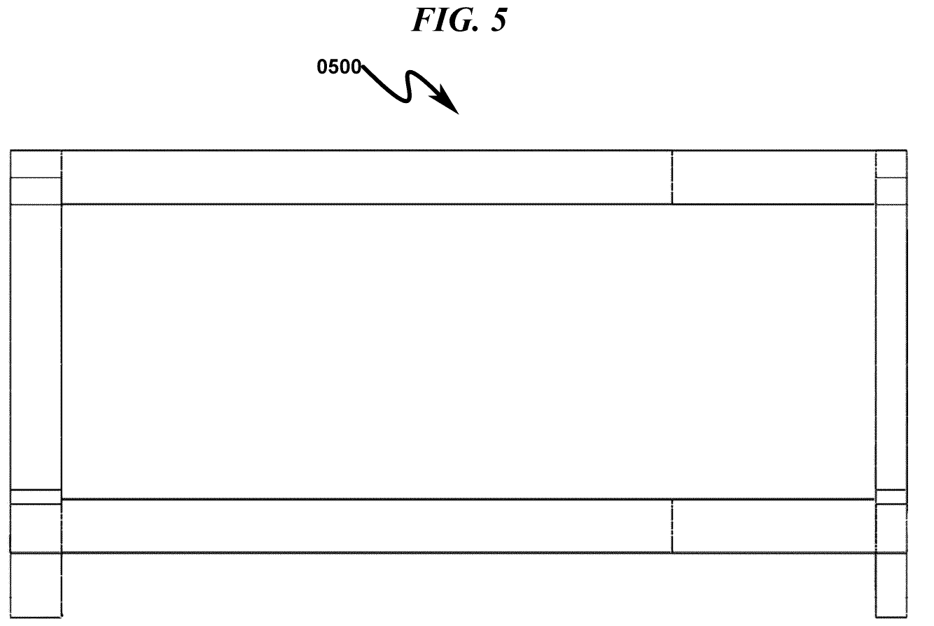

FIG. 6 illustrates a right side view of a preferred exemplary invention embodiment;

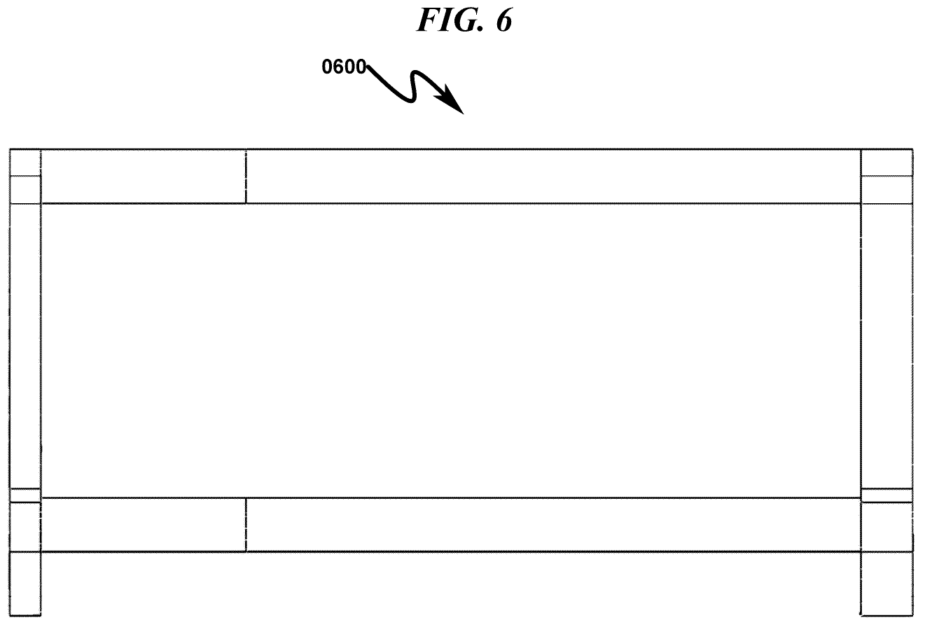

FIG. 7 illustrates a top view of a preferred exemplary invention embodiment;

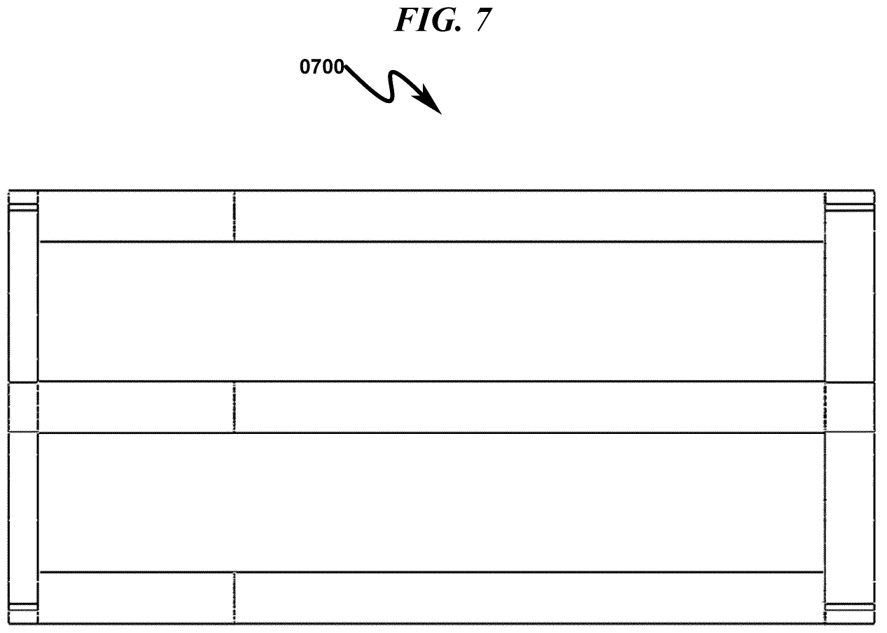

FIG. 8 illustrates a bottom view of a preferred exemplary invention embodiment;

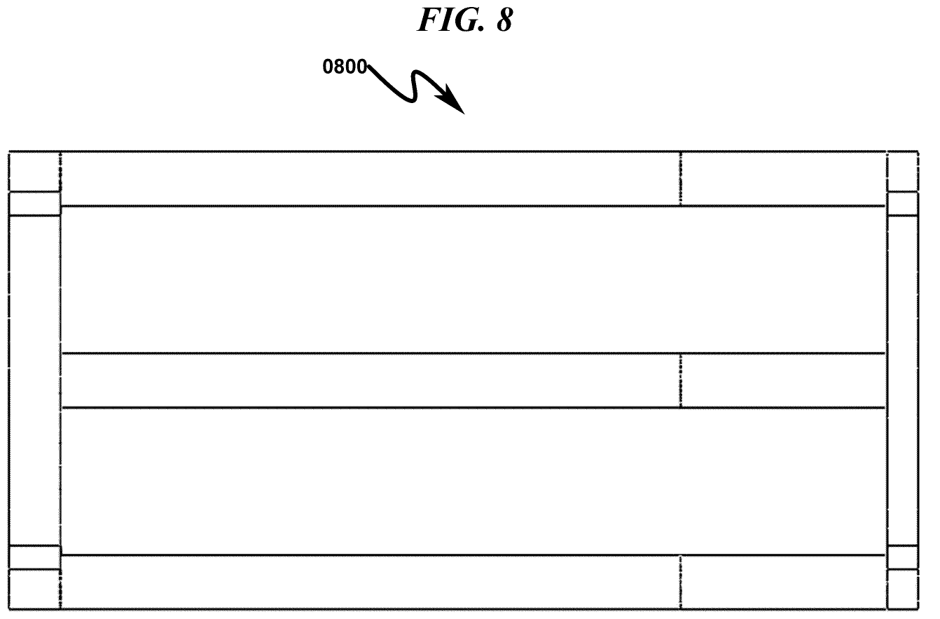

FIG. 9 illustrates a top right front perspective view of a preferred exemplary invention embodiment;

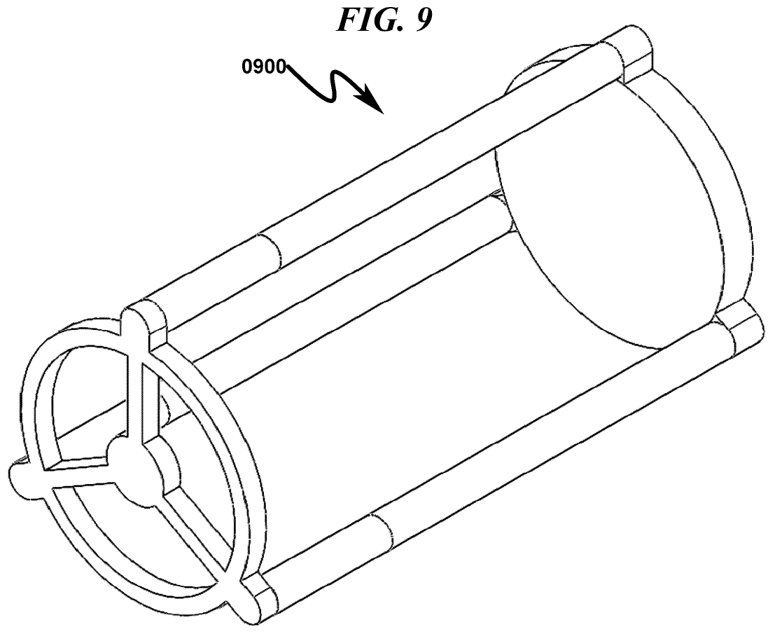

FIG. 10 illustrates a top right rear perspective view of a preferred exemplary invention embodiment;

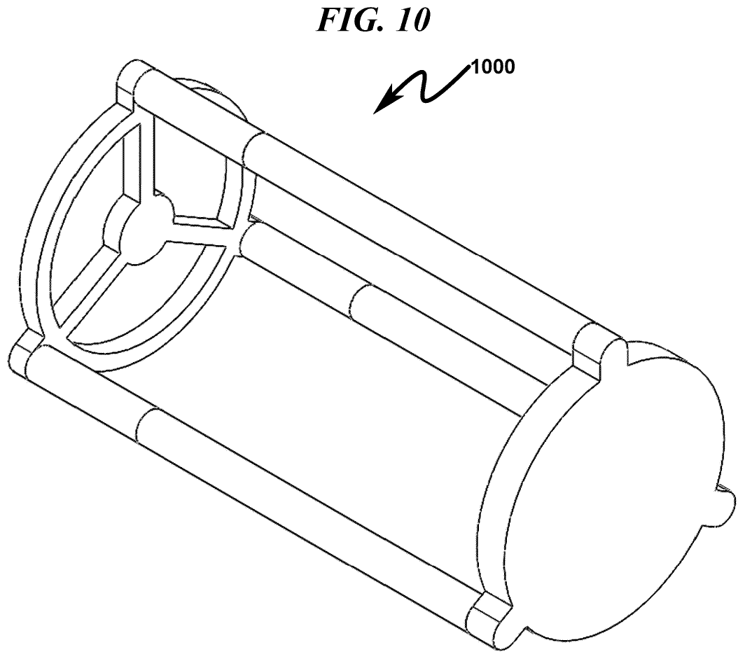

FIG. 11 illustrates a top left rear perspective view of a preferred exemplary invention embodiment;

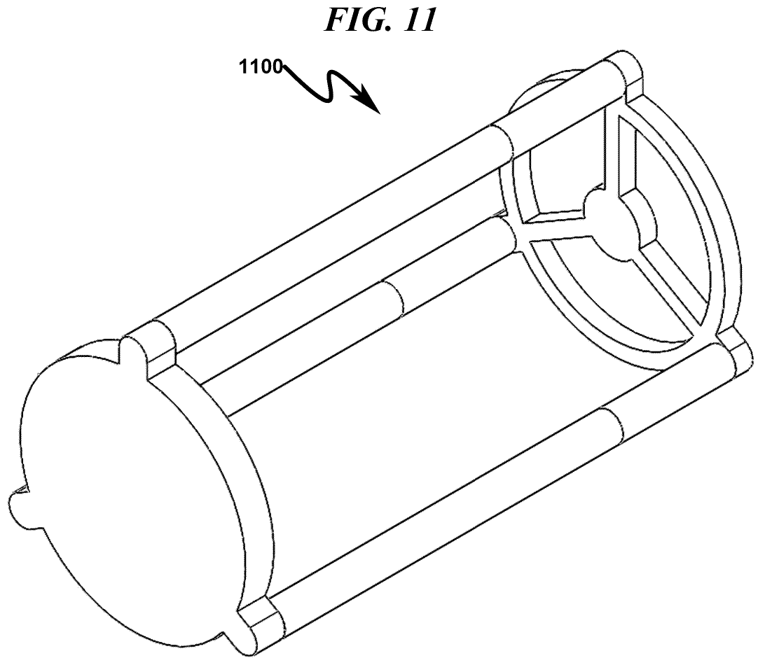

FIG. 12 illustrates a top left front perspective view of a preferred exemplary invention embodiment;

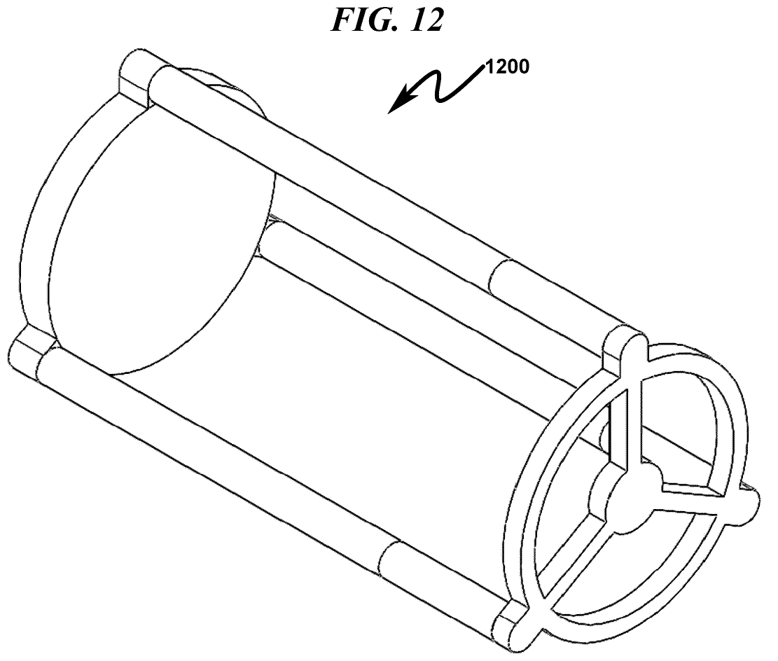

FIG. 13 illustrates a bottom right front perspective view of a preferred exemplary invention embodiment;

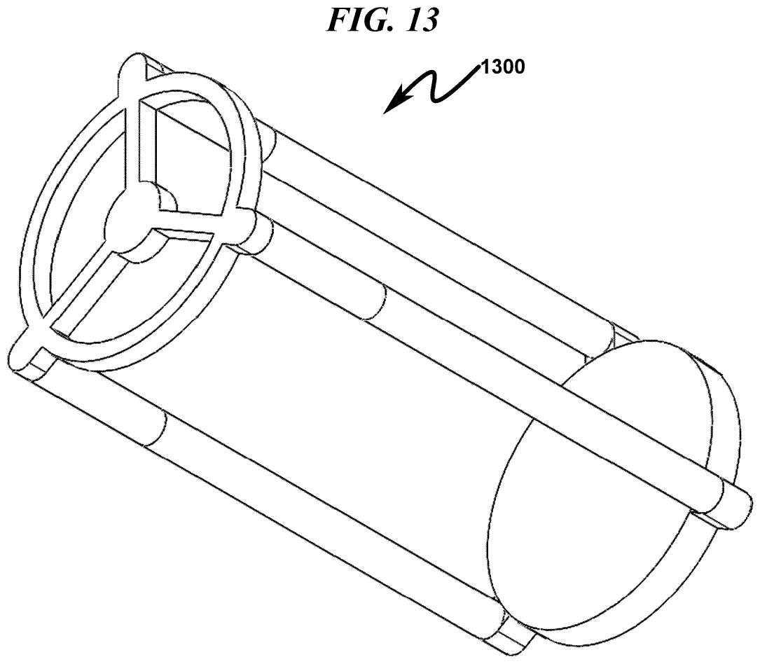

FIG. 14 illustrates a bottom right rear perspective view of a preferred exemplary invention embodiment;

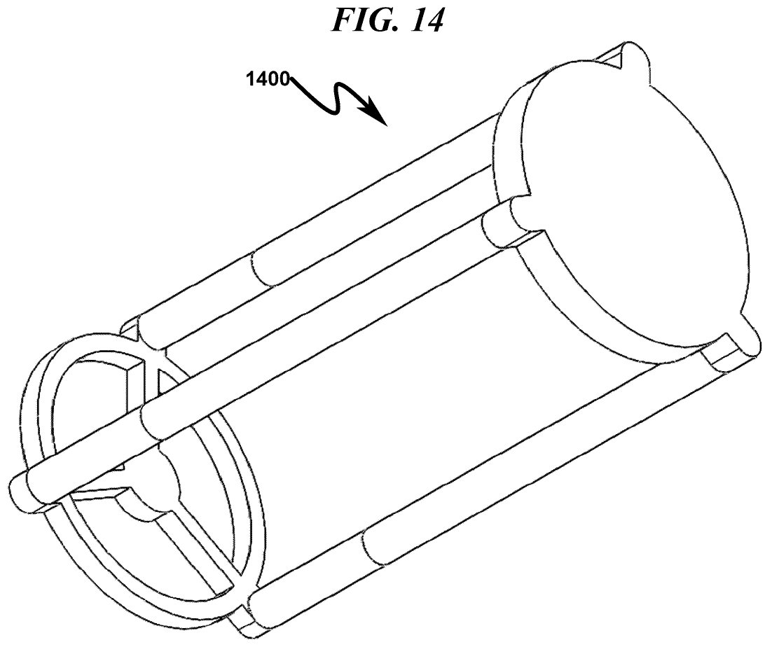

FIG. 15 illustrates a bottom left rear perspective view of a preferred exemplary invention embodiment;

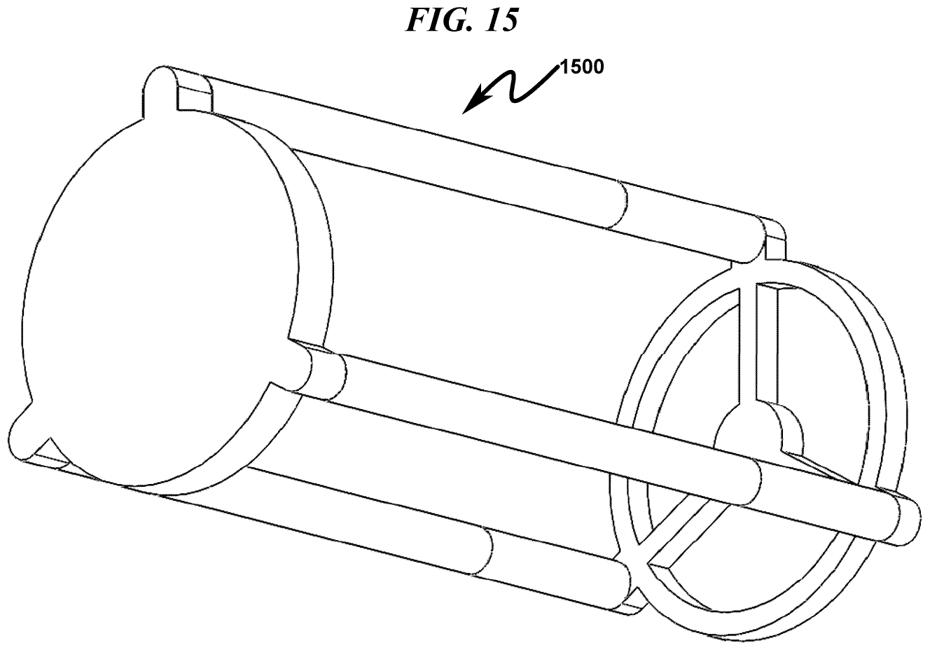

FIG. 16 illustrates a bottom left front perspective view of a preferred exemplary invention embodiment;

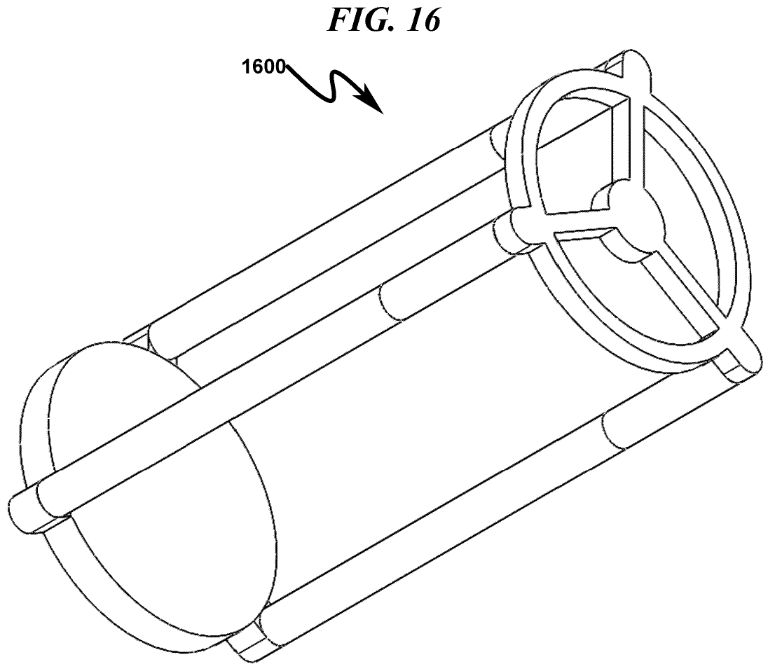

FIG. 17 illustrates a top right front perspective right section view of a preferred exemplary invention embodiment;

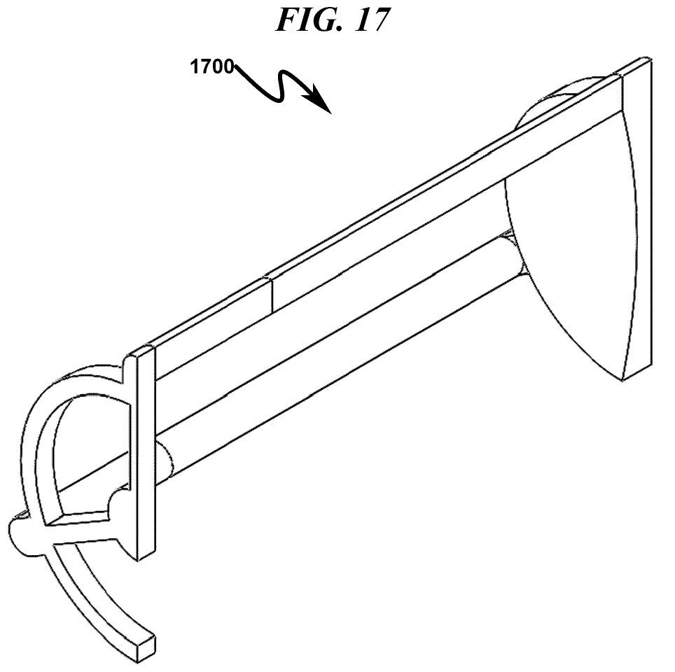

FIG. 18 illustrates a top right rear perspective right section view of a preferred exemplary invention embodiment;

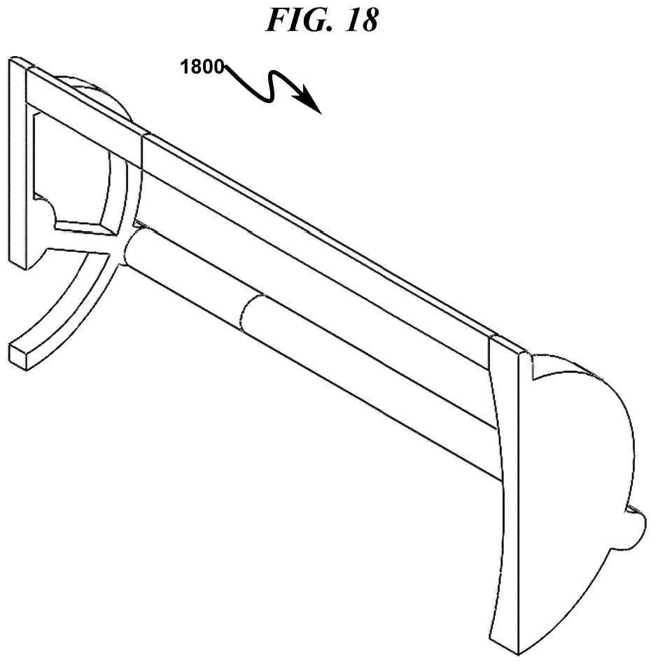

FIG. 19 illustrates a bottom right front perspective right section view of a preferred exemplary invention embodiment;

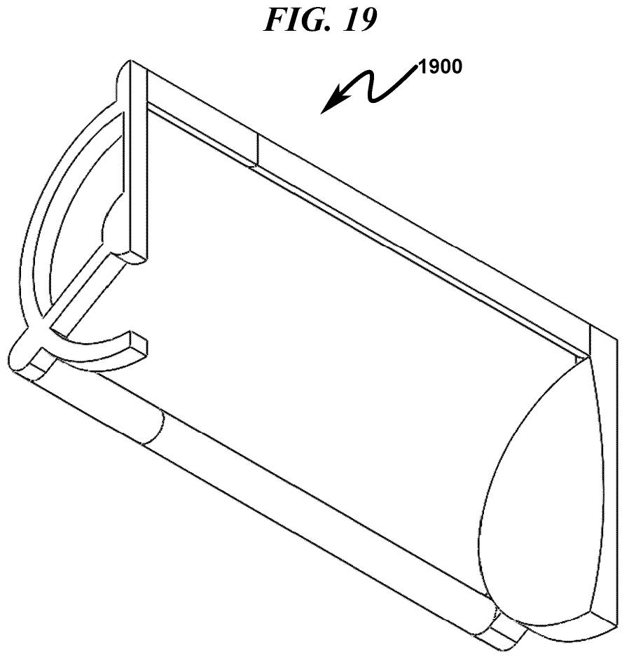

FIG. 20 illustrates a bottom right rear perspective right section view of a preferred exemplary invention embodiment;

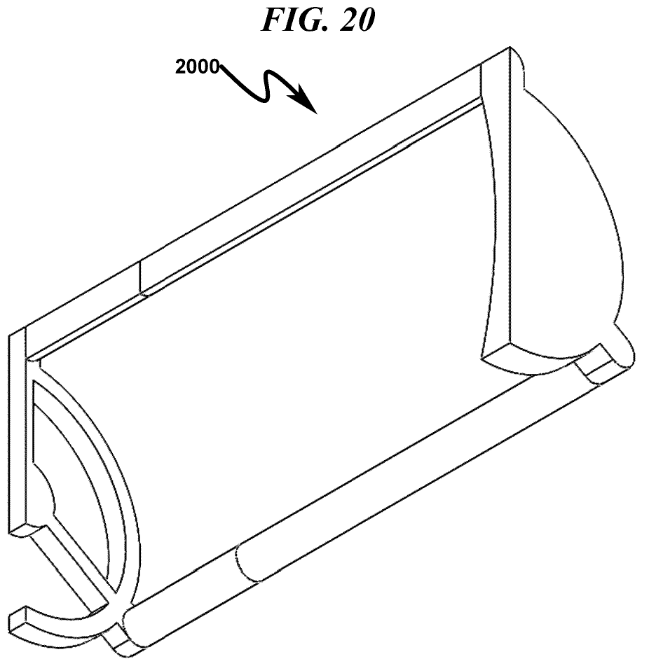

FIG. 21 illustrates a top right front perspective top section view of a preferred exemplary invention embodiment;

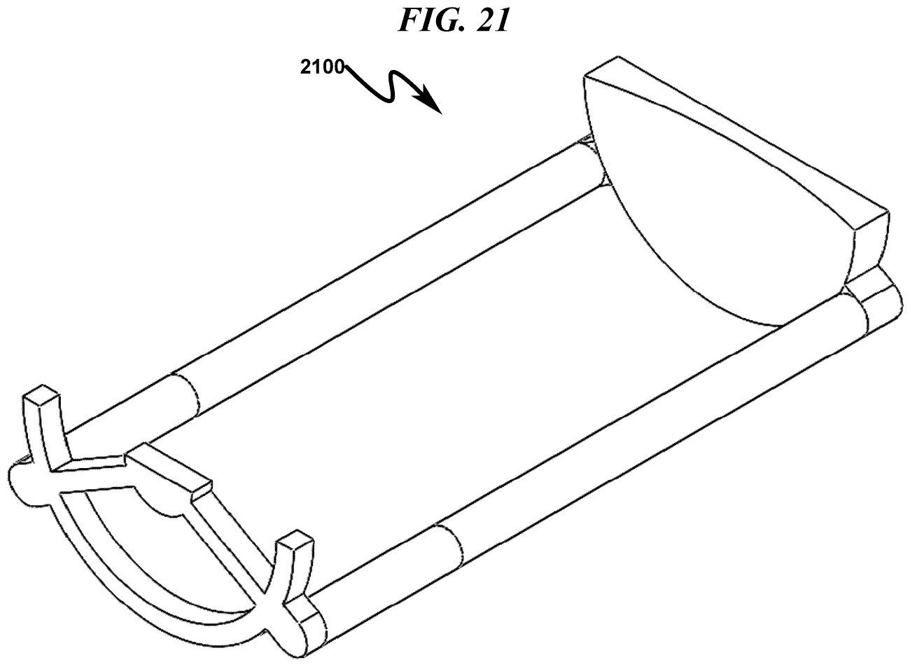

FIG. 22 illustrates a top right rear perspective top section view of a preferred exemplary invention embodiment;

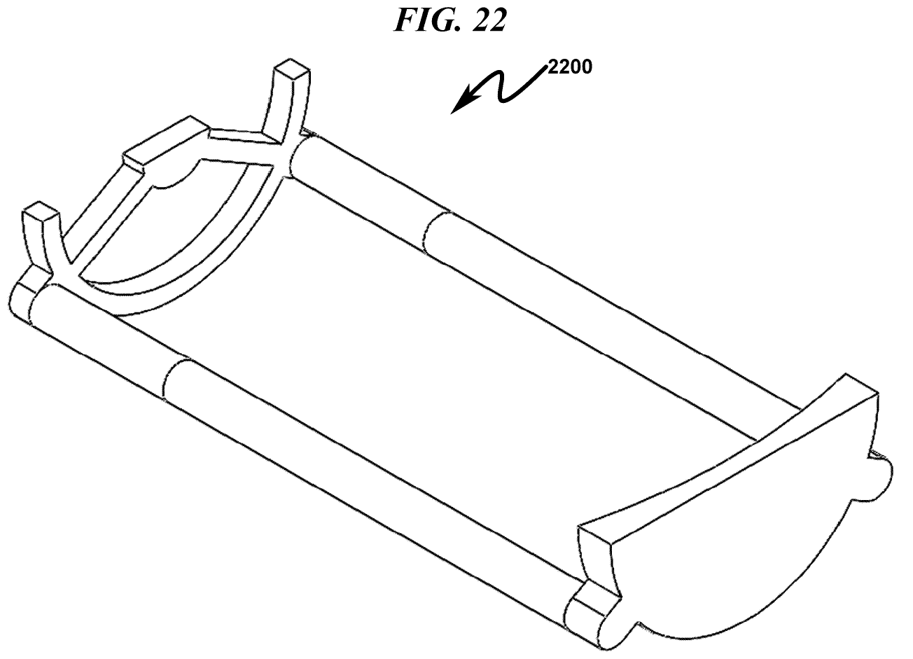

FIG. 23 illustrates a top left rear perspective top section view of a preferred exemplary invention embodiment;

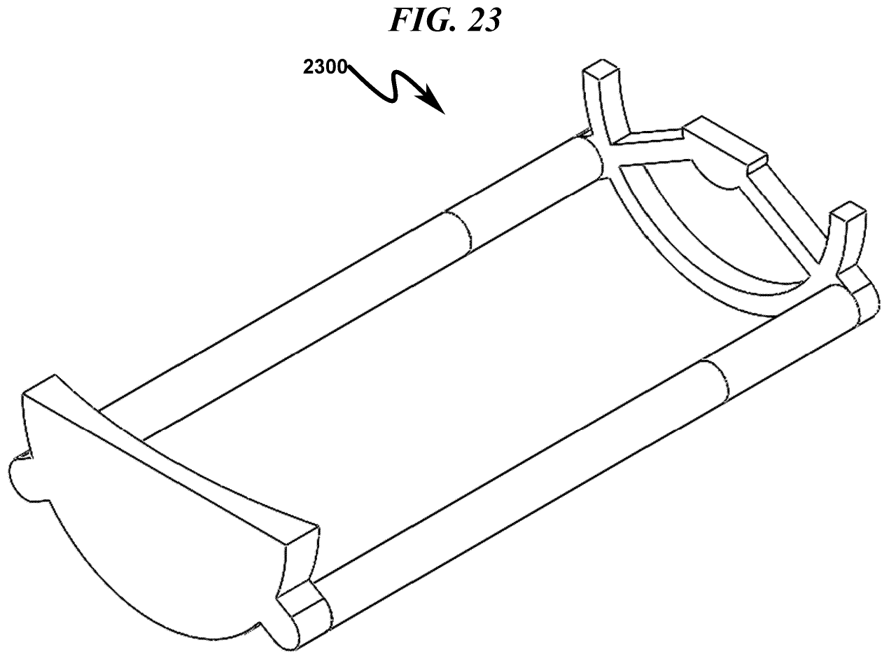

FIG. 24 illustrates a top left front perspective top section view of a preferred exemplary invention embodiment;

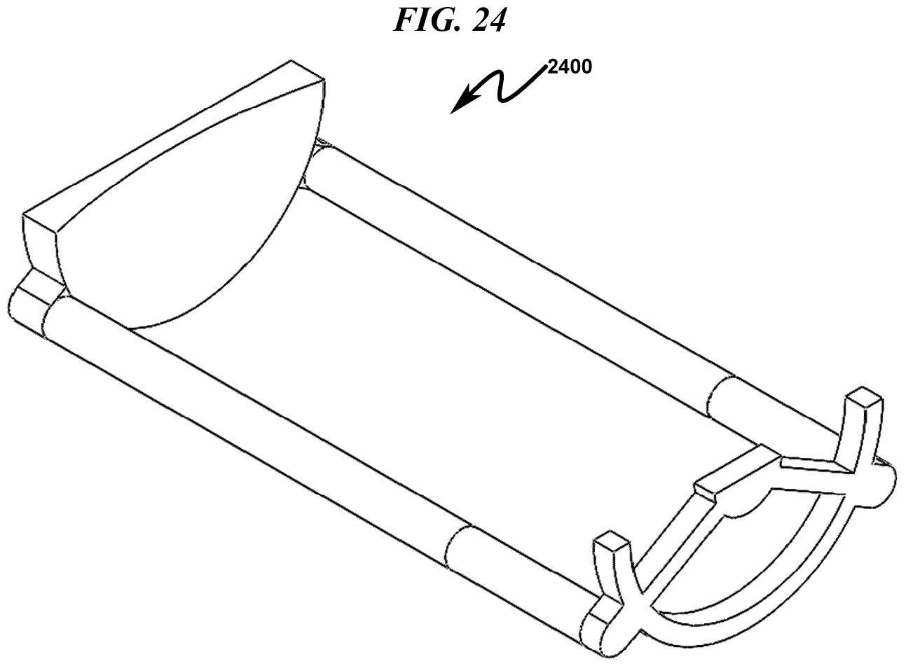

FIG. 25 illustrates a top right front perspective assembly view of a preferred exemplary invention embodiment;

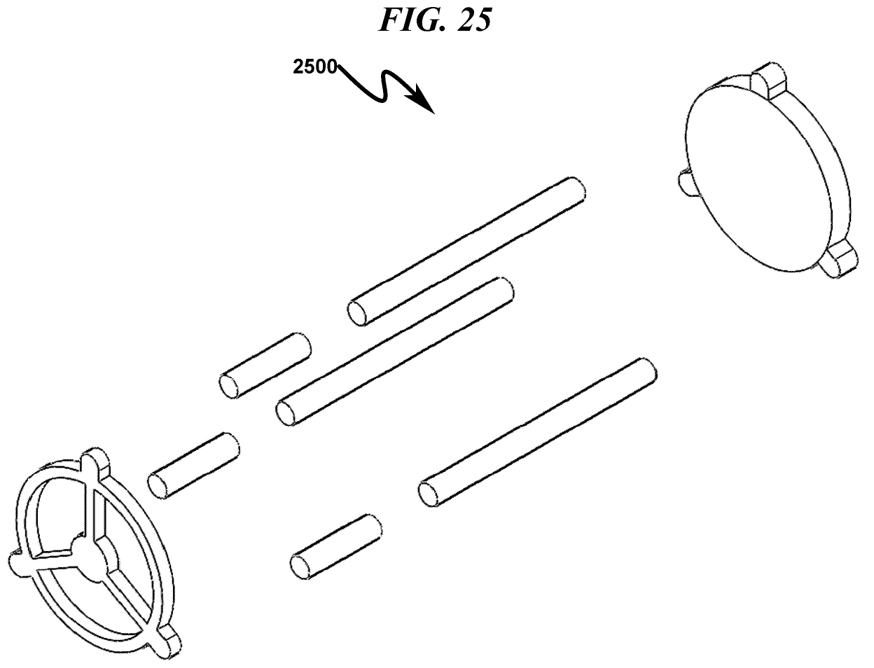

FIG. 26 illustrates a top right rear perspective assembly view of a preferred exemplary invention embodiment;

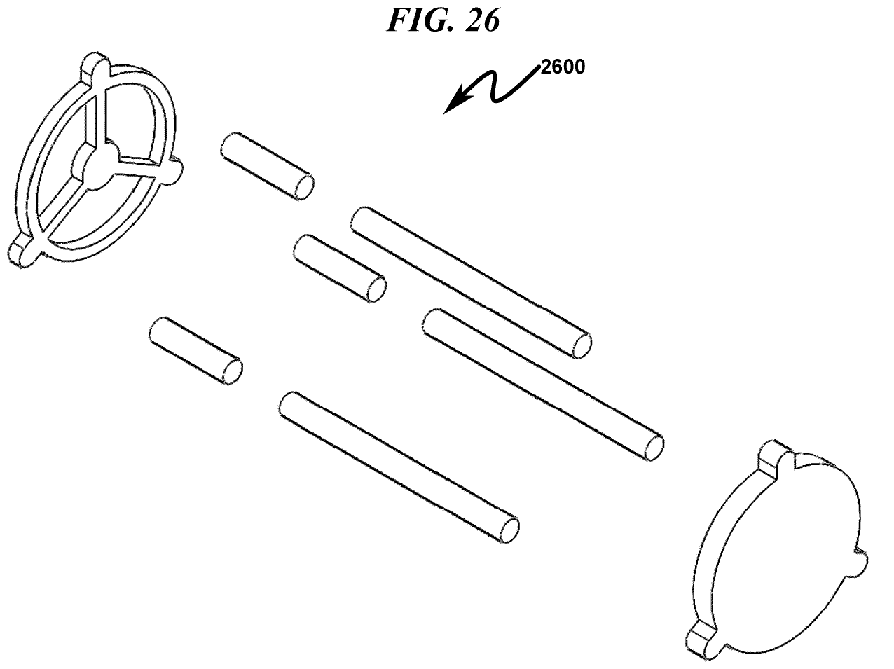

FIG. 27 illustrates a top left rear perspective assembly view of a preferred exemplary invention embodiment;

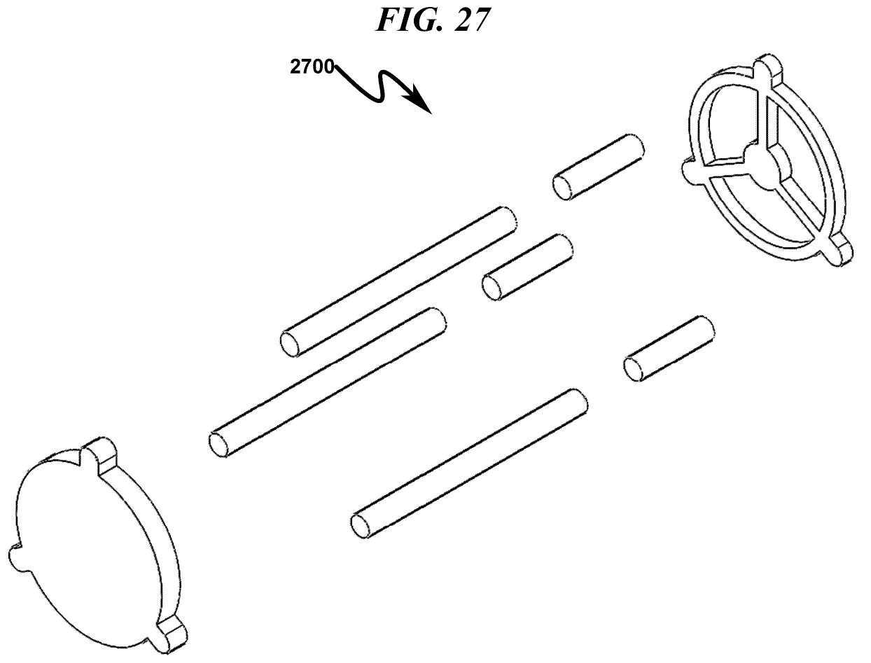

FIG. 28 illustrates a top left front perspective assembly view of a preferred exemplary invention embodiment;

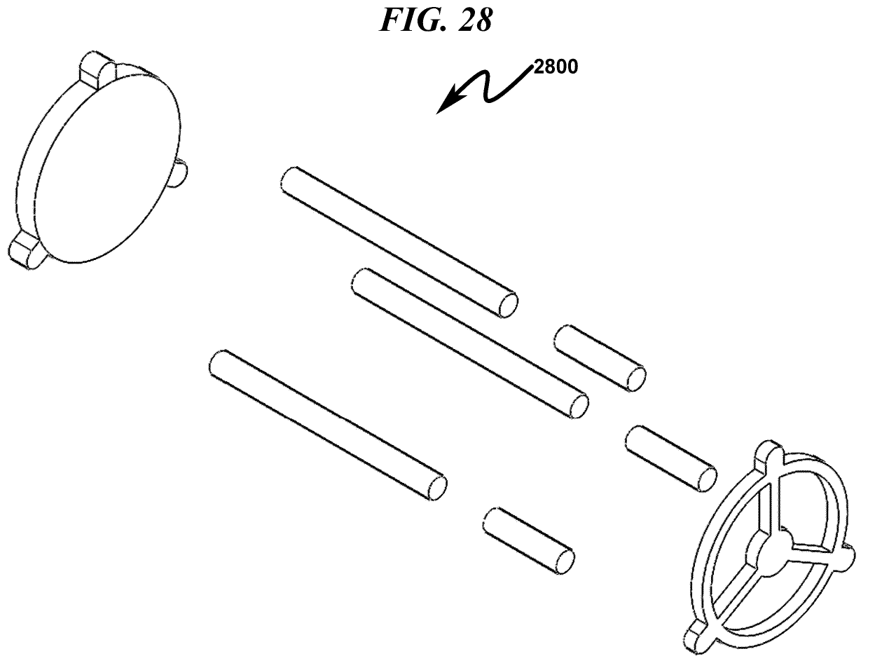

FIG. 29 illustrates a top right front perspective right section assembly view of a preferred exemplary invention embodiment;

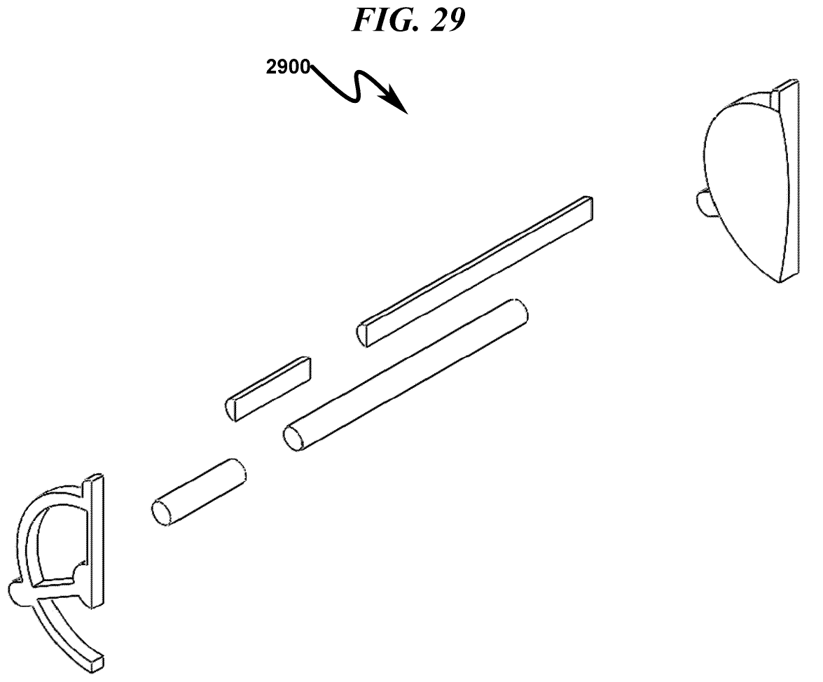

FIG. 30 illustrates a top right rear perspective right section assembly view of a preferred exemplary invention embodiment;

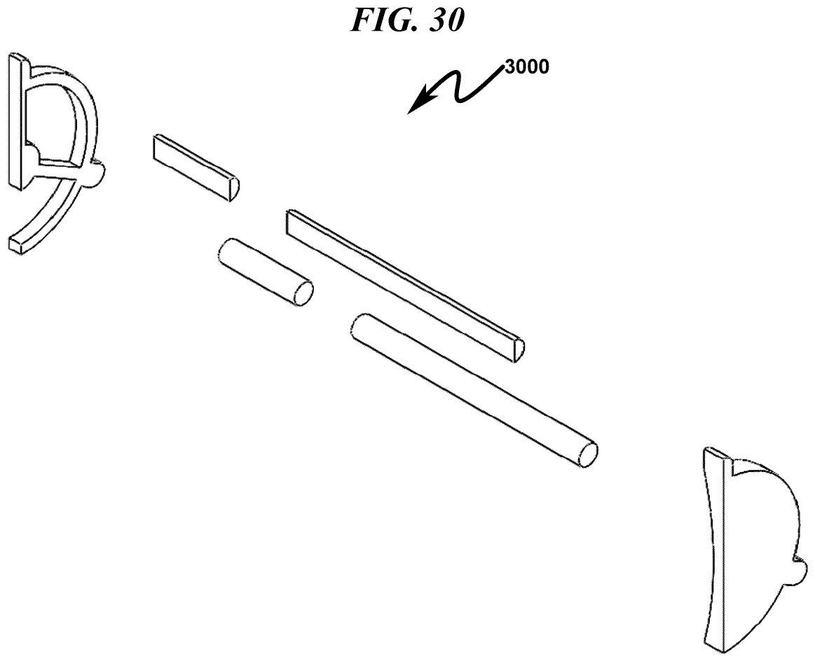

FIG. 31 illustrates a top right front perspective top section assembly view of a preferred exemplary invention embodiment;

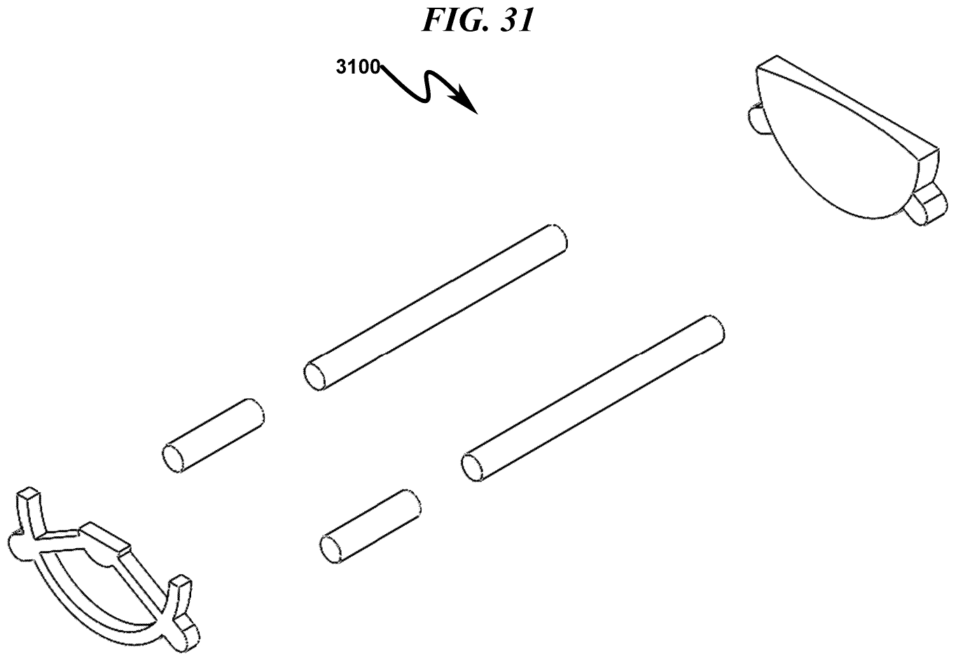

FIG. 32 illustrates a top right rear perspective top section assembly view of a preferred exemplary invention embodiment;

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a TELESCOPE SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Metering Rod Structure Not Limitive

While preferred embodiments of the present invention as depicted herein represent the metering rods (FMR, SMR, TMR, etc.) used to separate the optical mirror source (OMS) and optical focal target (OFT) as solid cylinders, the present invention views the construction of these elements broadly, and they may include other construction forms including tubular elements, pipe, solid and/or hollow extrusions, polygonal forms, and the like.

### Nomenclature Not Limitive

Within this document the phrase “series tailored athermally stabilized optical (STASO) system” may be abbreviated as “STATOS” and the phrase “series tailored athermally stabilized optical (STASO) method” may be abbreviated as “STATOM.”

### Tailored Thermal Expansion Coefficient (TEC) Defined

The term “tailored thermal expansion coefficient (TEC)” as used herein to describe the formulation and manufacture of the temperature compensating member (TCM) refers to the methods and products of material manufacture described in United States Utility patent applications that are included by reference in this patent application.

These patent applications teach the fabrication of metallic materials that have a range of tailored thermal expansion coefficients that are outside of those available using conventional A286, INCONEL 903, WASPALOY, Invar, or other materials known to those of skill in the art as described in the prior art included-by-reference document SAE AIR1754B Aerospace Information Report for “Washer, Thermal Compensating, Metric Series” from SAE International (www.sae.org), Issued 1981-12, Revised 2001 October, Reaffirmed 2012 October, Stabilized 2019 February, Superseding AIR1754A. Since this document was stabilized in February 2019 (38 years after first issuance) as of this date the document indicates that were no known methodologies of achieving thermally stabilized fasteners or separators other than that provided in this SAE standard. As such, the present invention as described herein is novel with respect to the disclosure scope of this SAE document.

### System Overview (0100)

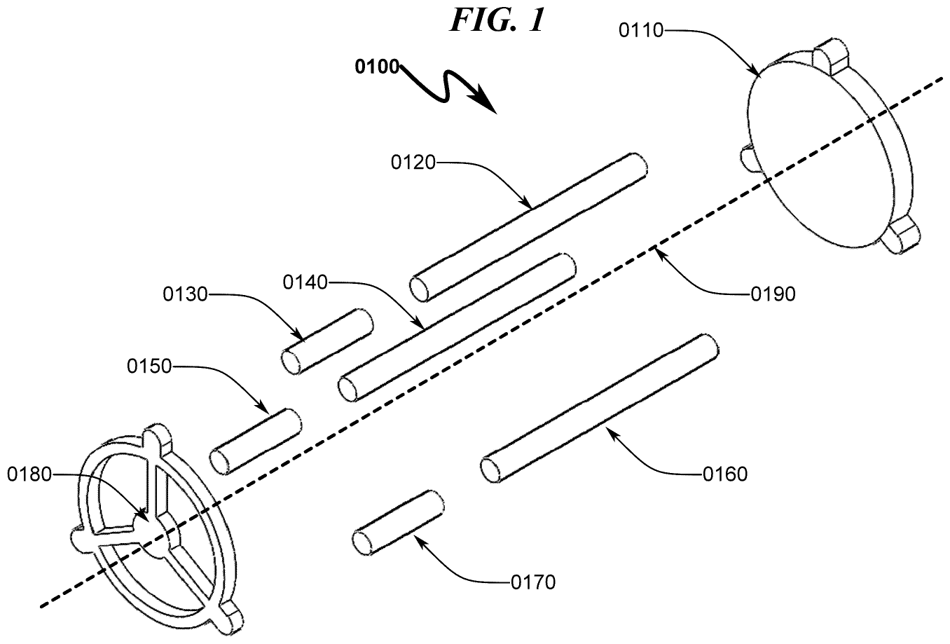

FIG. 1 (0100)) depicts an assembly view of a preferred exemplary invention embodiment illustrating a series tailored athermally stabilized optical (STASO) telescope system. The disclosed system separates an optical mirror source (OMS) (0110) and an optical focal target (OFT) (0180) via a first metering rod (FMR) (0120, 0130), second metering rod (SMR) (0140, 0150), and third metering rod (TMR) (0160, 0170) where the FMR, SMR, and TMR each comprise a first retaining rod (FRR) (0120, 0140, 0160) comprised of a material having a first thermal expansion (FTE) coefficient and a second retaining rod (SRR) (0130, 0150, 0170) comprised of a material having a second thermal expansion (STE) coefficient. The FMR, SMR, and TMR are constructed so as to be athermally stabilized to ensure that the OMS (0110) and OFT (0180) remain separated at a constant or controlled distance over a predetermined temperature range by selection of appropriate FTE and STE coefficients.

This OFD may constitute a static distance and/or may incorporate a positive and/or negative thermal coefficient of expansion that complements thermal characteristics of the OMS (0110) and/or OFT (0180) so as to stabilize the OFD between the OMS (0110) and OFT (0180) over a predetermined range of temperatures.

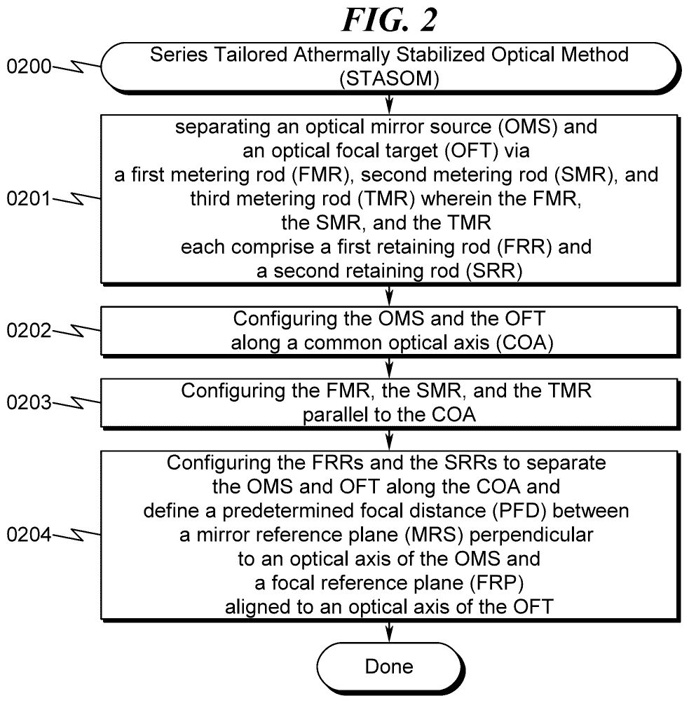

The present invention may implement a method in which a thermally stabilized telescope is designed using TEC materials fabricated to compensate a tubular separator combination. In this thermally stabilized telescope methodology, as generally depicted in FIG. 2 (0200), the present invention may be broadly generalized as a series tailored athermally stabilized optical (STASO) telescope method comprising:
separating an optical mirror source (OMS) and an optical focal target (OFT) via a first metering rod (FMR), second metering rod (SMR), and third metering rod (TMR) wherein the FMR, the SMR, and the TMR each comprise a first retaining rod (FRR) and a second retaining rod (SRR) (0201);
configuring the OMS and the OFT along a common optical axis (COA) (0202);
configuring the FMR, the SMR, and the TMR parallel to the COA (0203); and configuring the FRRs and the SRRs to separate the OMS and OFT along the COA and define a predetermined focal distance (PFD) between a mirror reference plane (MRS) perpendicular to an optical axis of the OMS and a focal reference plane (FRP) aligned to an optical axis of the OFT (0204);
wherein:
the FRR comprises a material having a first thermal expansion (FTE) coefficient;
the SRR comprises of a material having a second thermal expansion (STE) coefficient;
the FRR is constructed from a thermalized metallic material (TMM) selected to produce in combination with the SRR a thermally neutral or controlled optical (TNO) variation in the PFD;
the TMM is constructed by deforming a metallic material by applying tension in a first direction;
the TMM, subsequent to the deformation, exhibits a first thermal expansion characteristic having a coefficient of thermal expansion within a predetermined range;
the coefficient of thermal expansion is in at least the first direction; and the TMM, subsequent to the deformation, exhibits a second thermal expansion characteristic in a second direction; and
wherein the TMM comprises a material selected from a group consisting of:
   a material characterized by a general formula Ti_{100-A}X_{A}, wherein X is at least one of Ni, Nb, Mo, Ta, Pd, Pt, or combinations thereof, and A is in a range from 0 to 75 atomic percent composition;
   a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
   a material characterized by a general formula Ti_{100-A-B}Nb_{A}X_{B}, wherein X is at least one of Al, Sn, Ta, Hf, Zr, Al, Au, Pt, Fe, Co, Cr, Mo, V, 0, or combinations thereof, and A is in a range from 0 to 55 atomic percent composition, and B is in a range from 0 to 75 atomic percent composition such that A plus B is less than 100; and
   a material characterized by a general formula Ti_{100-A-B}Ta_{A}X_{B}, wherein X is at least one of Al, Sn, Nb, Zr, Mo, Al, Au, Pt, Fe, Co, Cr, Hf, V, 0, or combinations thereof, and A is in a range from 0 to 55 atomic percent composition, and B is in a range from 0 to 75 atomic percent composition such that A plus B is less than 100.
      This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Exemplary TCM Materials

The TCM candidate materials may be selected from a list of materials that have been discovered to exhibit the required CTE when combined as indicated below:
Ti_{100-A}X_{A} (X=at least one of Ni, Nb, Mo, Ta, Pd, Pt, or combinations thereof) (A=0 to 75 atomic percent composition), Ti_{100-A-B}Ni_{A}X_{B} (X=at least one of Pd, Hf, Zr, Al, Pt, Au, Fe, Co, Cr, Mo, V, 0 or combinations thereof) (A=0 to 55 atomic percent composition and B=0 to 75 atomic percent composition such that A+B<100), Ti_{100-A-B}Nb_{A}X_{B} (X=at least one of Al, Sn, Ta, Hf, Zr, Al, Au, Pt, Fe, Co, Cr, Mo, V, 0, or combinations thereof) (A=0 to 55 atomic percent composition and B=0 to 75 atomic percent composition such that A+B<100), Ti_{100-A-B}Ta_{A}X_{B} (X=at least one of Al, Sn, Nb, Zr, Mo, Al, Au, Pt, Fe, Co, Cr, Hf, V, 0, or combinations thereof) (A=0 to 55 atomic percent composition and B=0 to 75 atomic percent composition such that A+B<100), Ni_{100-A-B}Mn_{A}X_{B} (X=at least one of Ga, In, Sn, Al, Sb, Co, or combinations thereof) (A=0 to 50 atomic percent composition and B=0 to 50 atomic percent composition such that A+B<100), Ni_{100-A-B-C}Mn_{A}Co_{B}X_{C} (X=at least one of Ga, In, Sn, Al, Sb, or combinations thereof) (A=0 to 50 atomic percent composition, B=0 to 50 atomic percent composition, and C=0 to 50 atomic percent composition such that A+B+C<100), Ni_{100-A-B}Fe_{A}Ga_{B} (A=0 to 50 atomic percent composition and B=0 to 50 atomic percent composition such that A+B<100), Cu_{100-A}X_{A} (X=at least one of Zn, Ni, Mn, Al, Be, or combinations thereof) (A=0 to 75 atomic percent composition), Cu_{100-A-B}Al_{A}X_{B} (X=at least one of Zn, Ni, Mn, Be, or combinations thereof) (A=0 to 50 atomic percent composition and B=0 to 50 atomic percent composition such that A+B<100), Cu_{100-A-B-C}Mn_{A}Al_{B}X_{C} (X=at least one of Zn, Ni, Be, or combinations thereof) (A=0 to 50 atomic percent composition, B=0 to 50 atomic percent composition, and C=0 to 50 atomic percent composition such that A+B+C<100), Co_{100-A-B}Ni_{A}X_{B} (X=at least one of Al, Ga, Sn, Sb, In, or combinations thereof) (A=0 to 50 atomic percent composition and B=0 to 50 atomic percent composition such that A+B<100), Fe_{100-A-B}Mn_{A}X_{B} (X=at least one of Ga, Ni, Co, Al, Ta, Si, or combinations thereof) (A=0 to 50 atomic percent composition and B=0 to 50 atomic percent composition such that A+B<100), Fe_{100-A-B}Ni_{A}X_{B} (X=at least one of Ga, Mn, Co, Al, Ta, Si, or combinations thereof) (A=0 to 50 atomic percent composition and B=0 to 50 atomic percent composition such that A+B<100), Fe_{100-A-B-C}Ni_{A}CO_{B}Al_{C}X_{D} (X=at least one of Ti, Ta, Nb, Cr, W or combinations thereof) (A=0 to 50 atomic percent composition, B=0 to 50 atomic percent composition, C=0 to 50 atomic percent composition, and D=0 to 50 atomic percent composition such that A+B+C+D<100), Fe_{100-A-B-C}Ni_{A}Co_{B}Ti_{C}X_{D} (X=at least one of Al, Ta, Nb, Cr, W or combinations thereof) (A=0 to 50 atomic percent composition, B=0 to 50 atomic percent composition, C=0 to 50 atomic percent composition, and D=0 to 50 atomic percent composition such that A+B+C+D<100), and combinations thereof that exhibit martensitic transformation.
NiTi, NiTiPd, NiTiHf, NiTiPt, NiTiAu, NiTiZr, NiMn, NiMnGa, NiMnSn, NiMnIn, NiMnAl, NiMnSb, NiCoMn, NiCoMnGa, NiCoMnSn, NiCoMnAl, NiCoMnIn, NiCoMnSb, NiFeGa, MnFeGa, TiNb, TiMo, TiNbAl, TiNbSn, TiNbTa, TiNbZr, TiNbO, CuMnAlNi, CuMnAl, CuZnAl, CuNiAl, CuAlBe, CoNi, CoNiAl, CoNiGa, FeMn, FeMnGa, FeMnNi, FeMnCo, FeMnAl, FeMnTa, FeMnNiAl, FeNiCoAl, FeNiCoAlTa, FeNiCoAlTi, FeNiCoAlNb, FeNiCoAlW, FeNiCoAlCr, FeMnSi, FeNiCo, FeNiCoTi, as well as derivations and combinations thereof that exhibit martensitic transformation.

Other TCM materials may be utilized as described in United States Utility patent application for CONTROLLED THERMAL COEFFICIENT PRODUCT SYSTEM AND METHOD by inventors James Alan Monroe, Ibrahim (nmn) Karaman, and Raymundo (nmn) Arroyave, filed with the USPTO on Jul. 22, 2016, with Ser. No. 15/217,594, EFS ID 26434102, confirmation number 5258, docket TAMUS 3809 CIP, and other patents/patent applications incorporated herein.

### Exemplary System Construction (0300)-(3200)

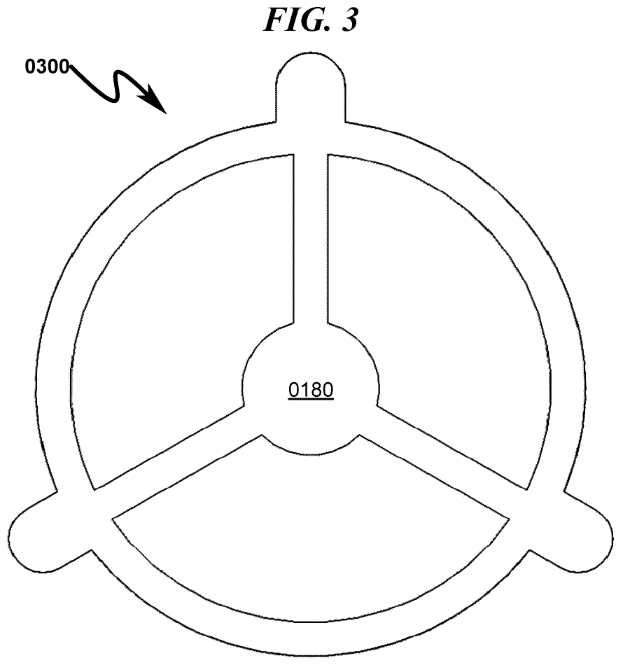

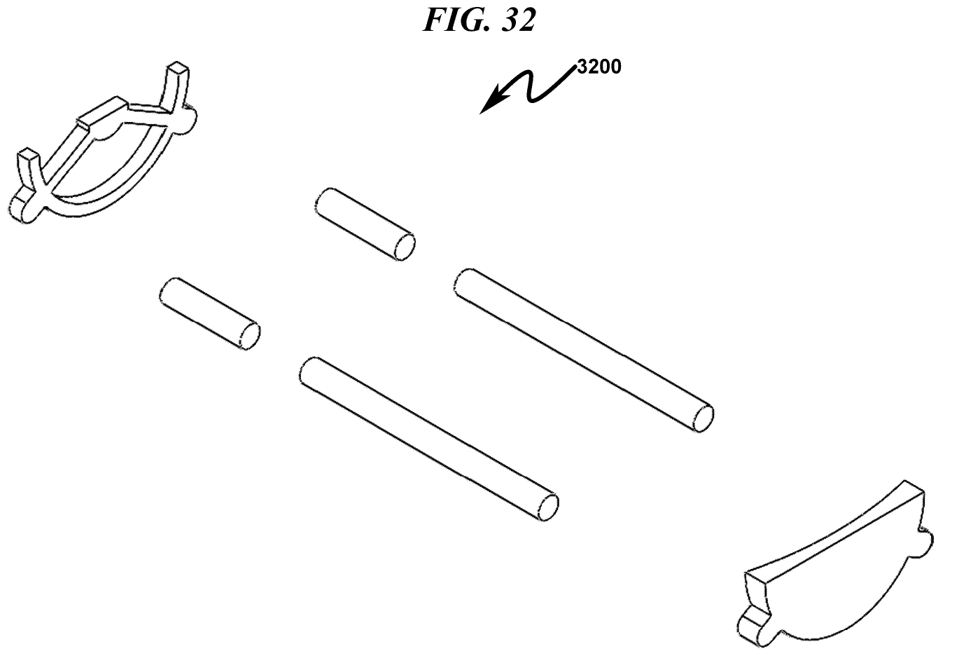

The present invention system in a preferred exemplary embodiment is generally illustrated in the various views of FIG. 3 (0300)-FIG. 32 (3200). One skilled in the art may recognize that this construction is only exemplary of many configurations in which the focal distance between the optical mirror source (OMS) and optical focal target (OFT) is thermally astabilized via separation using a first metering rod (FMR), second metering rod (SMR), and third metering rod (TMR) where the FMR, SMR, and TMR each comprise a first retaining rod (FRR) comprised of a material having a first thermal expansion (FTE) coefficient and a second retaining rod (SRR) comprised of a material having a second thermal expansion (STE) coefficient.

### System Summary

The present invention system may be broadly generalized as a series tailored athermally stabilized optical (STASO) telescope system (STASOS) comprising:
(a) optical mirror source (OMS);
(b) optical focal target (OFT);
(c) first metering rod (FMR);
(d) second metering rod (SMR); and
(e) third metering rod (TMR);
wherein:
the OMS comprises a mirror reference surface (MRS) perpendicular to an optical axis of the OMS;
the OFT comprises a focal reference plane (FRP) aligned to an optical axis of the OFT;
the FMR, the SMR and the TMR each comprise a first retaining rod (FRR) comprised of a material having a first thermal expansion (FTE) coefficient;
the FMR, the SMR and the TMR each comprise a second retaining rod (SRR) comprised of a material having a second thermal expansion (STE) coefficient;
the FMR, the SMR and the TMR are aligned parallel to the optical axis of the OMS;
the FMR, the SMR and the TMR are configured to align the OMS and OFT along a common optical axis (COA);
the FMR, the SMR and the TMR are configured to separate the OMS and the OFT along the COA and define a predetermined focal distance (PFD) between the MRS and the FRP;
the FRR is constructed from a thermalized metallic material (TMM) selected to produce in combination with the SRR a thermally neutral or controlled optical (TNO) variation in the PFD;
the TMM is constructed by deforming a metallic material by applying tension in a first direction;
the TMM, subsequent to the deformation, exhibits a first thermal expansion characteristic having a coefficient of thermal expansion within a predetermined range;
the coefficient of thermal expansion is in at least the first direction; and
the TMM, subsequent to the deformation, exhibits a second thermal expansion characteristic in a second direction; and
wherein the TMM comprises a material selected from a group consisting of:
   (1) a material characterized by a general formula Ti_{100-A}X_{A}, wherein X is at least one of Ni, Nb, Mo, Ta, Pd, Pt, or combinations thereof, and A is in a range from 0 to 75 atomic percent composition;
   (2) a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
   (3) a material characterized by a general formula Ti_{100-A-B}Nb_{A}X_{B}, wherein X is at least one of Al, Sn, Ta, Hf, Zr, Al, Au, Pt, Fe, Co, Cr, Mo, V, 0, or combinations thereof, and A is in a range from 0 to 55 atomic percent composition, and B is in a range from 0 to 75 atomic percent composition such that A plus B is less than 100; and
   (4) a material characterized by a general formula Ti_{100-A-B}Ta_{A}X_{B}, wherein X is at least one of Al, Sn, Nb, Zr, Mo, Al, Au, Pt, Fe, Co, Cr, Hf, V, 0, or combinations thereof, and A is in a range from 0 to 55 atomic percent composition, and B is in a range from 0 to 75 atomic percent composition such that A plus B is less than 100.
      This general system summary may be augmented by the various elements described herein to produce a wide variety of invention embodiments consistent with this overall design description.

### Method Summary

A preferred exemplary embodiment of the present invention method may be broadly generalized as a series tailored athermally stabilized optical (STASO) telescope method (STASOM) comprising:
separating an optical mirror source (OMS) and an optical focal target (OFT) via a first metering rod (FMR), second metering rod (SMR), and third metering rod (TMR) wherein the FMR, the SMR, and the TMR each comprise a first retaining rod (FRR) and a second retaining rod (SRR);
configuring the OMS and the OFT along a common optical axis (COA);
configuring the FMR, the SMR, and the TMR parallel to the COA; and
configuring the FRRs and the SRRs to separate the OMS and OFT along the COA and define a predetermined focal distance (PFD) between a mirror reference plane (MRS) perpendicular to an optical axis of the OMS and a focal reference plane (FRP) aligned to an optical axis of the OFT;
wherein:
the FRR comprises a material having a first thermal expansion (FTE) coefficient;
the SRR comprises of a material having a second thermal expansion (STE) coefficient;
the FRR is constructed from a thermalized metallic material (TMM) selected to produce in combination with the SRR a thermally neutral or controlled optical (TNO) variation in the PFD;
the TMM is constructed by deforming a metallic material by applying tension in a first direction;
the TMM, subsequent to the deformation, exhibits a first thermal expansion characteristic having a coefficient of thermal expansion within a predetermined range;
the coefficient of thermal expansion is in at least the first direction; and
the TMM, subsequent to the deformation, exhibits a second thermal expansion characteristic in a second direction; and
wherein the TMM comprises a material selected from a group consisting of:
   a material characterized by a general formula Ti_{100-A}X_{A}, wherein X is at least one of Ni, Nb, Mo, Ta, Pd, Pt, or combinations thereof, and A is in a range from 0 to 75 atomic percent composition;
   a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
   a material characterized by a general formula Ti_{100-A-B}Nb_{A}X_{B}, wherein X is at least one of Al, Sn, Ta, Hf, Zr, Al, Au, Pt, Fe, Co, Cr, Mo, V, 0, or combinations thereof, and A is in a range from 0 to 55 atomic percent composition, and B is in a range from 0 to 75 atomic percent composition such that A plus B is less than 100; and
   a material characterized by a general formula Ti_{100-A-B}Ta_{A}X_{B}, wherein X is at least one of Al, Sn, Nb, Zr, Mo, Al, Au, Pt, Fe, Co, Cr, Hf, V, 0, or combinations thereof, and A is in a range from 0 to 55 atomic percent composition, and B is in a range from 0 to 75 atomic percent composition such that A plus B is less than 100.
      This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the deformation is achieved by at least one of:
   (1) hot-rolling;
   (2) cold-rolling;
   (3) plane strain compression;
   (4) bi-axial tension;
   (5) conform processing;
   (6) bending;
   (7) drawing;
   (8) wire-drawing;
   (9) swaging;
   (10) extrusion;
   (11) equal channel angular extrusion;
   (12) precipitation heat treatment under stress;
   (13) annealing;
   (14) sintering;
   (15) monotonic tension processing;
   (16) monotonic compression processing;
   (17) monotonic torsion processing;
   (18) cyclic thermal training under stress; and
   (19) combinations thereof.
An embodiment wherein the predetermined range of the coefficient of thermal expansion ranges from −150×10⁻⁶K⁻¹ to +500×10⁻⁶K⁻¹.
An embodiment wherein the deforming of the metallic material further comprises texturing the metallic material in a direction comprising at least one of a [111], a [100], or a [001] direction.
An embodiment wherein the TMM comprises a material having a negative thermal expansion (NTE) coefficient.
An embodiment wherein:
   the deforming the TMM comprises applying tension in at least one direction; and
   the second thermal expansion characteristic subsequent to the deformation is in at least one direction.
An embodiment wherein:
   the deforming the TMM comprises applying compression in first direction;
   the second thermal expansion characteristic subsequent to the deformation is in at least one predetermined direction; and
   the at least one predetermined direction is perpendicular to the first direction.
An embodiment wherein:
   the deforming the TMM comprises applying shear in the first direction;
   the second thermal expansion characteristic subsequent to deformation is in at least one predetermined direction; and
   the at least one predetermined direction is 45° to the first direction.
An embodiment wherein:
   the FMR, the SMR, and the TMR are each comprised of tubular elements defined by multiple the FRR and the SRR elements configured into an optical telescope assembly (OTA);
   the FRR and the SRR axes of the STASOS in the OTA are aligned parallel to the optical axis of the OMS;
   the OTA is axially symmetric along the optical axis of the OMS;
   the OTA is configured to attached directly or indirectly to the OMS; and
   the OTA is configured to separate the OMS and the OFT along the COA and define a predetermined distance between the MRS and the FRP.
An embodiment wherein:
   the PFD is defined by multiple the STASOS elements configured into an optical telescope assembly (OTA);
   the FRR and the SRR axes of the STASOS in the OTA are aligned at a pre-determined angle to the optical axis of the OMS;
   the OTA is axially symmetric along the optical axis of the OMS;
   the OTA is configured to attached directly or indirectly to the OMS; and
   the OTA is configured to separate the OMS and the OFT along the COA and define a predetermined distance between the MRS and the FRP.
An embodiment wherein:
   the PFD is defined by multiple the STASOS elements configured into an optical telescope assembly (OTA);
   the FRR and the SRR axes of the STASOS in the OTA are aligned parallel to the optical axis of the OMS;
   the OTA is not axially symmetric along and off-axis to the optical axis of the OMS;
   the OTA is configured to attached directly or indirectly to the OMS; and
   the OTA is configured to separate the OMS and the OFT along the COA and define a predetermined distance between the MRS and the FRP.
An embodiment wherein:
   the PFD is defined by multiple the STASOS elements configured into an optical telescope assembly (OTA);
   the FRR and the SRR axes of the STASOS in the OTA are aligned at a pre-determined angle to the optical axis of the OMS;
   the OTA is not axially symmetric along and off-axis to the optical axis of the OMS;
   the OTA is configured to attached directly or indirectly to the OMS; and
   the OTA is configured to separate the OMS and the OFT along the COA and define a predetermined distance between the MRS and the FRP.

One skilled in the art will recognize that other embodiments are possible based on combinations of elements taught within the above invention description.

### CONCLUSION

A series tailored athermally stabilized optical (STASO) telescope system (STASOS) and method (STASOM) has been disclosed. The disclosed system/method separates an optical mirror source (OMS) and an optical focal target (OFT) via a first metering rod (FMR), second metering rod (SMR), and third metering rod (TMR) where the FMR, SMR, and TMR each comprise a first retaining rod (FRR) comprised of a material having a first thermal expansion (FTE) coefficient and a second retaining rod (SRR) comprised of a material having a second thermal expansion (STE) coefficient. The FMR, SMR, and TMR are constructed so as to be athermally stabilized to ensure that the OMS and OFT remain separated at a constant or controlled distance over a predetermined temperature range by selection of appropriate FTE and STE coefficients.

### CLAIMS INTERPRETATION

The following rules apply when interpreting the CLAIMS of the present invention:
The CLAIM PREAMBLE should be considered as limiting the scope of the claimed invention.
“WHEREIN” clauses should be considered as limiting the scope of the claimed invention.
“WHEREBY” clauses should be considered as limiting the scope of the claimed invention.
“ADAPTED TO” clauses should be considered as limiting the scope of the claimed invention.
“ADAPTED FOR” clauses should be considered as limiting the scope of the claimed invention.
The term “MEANS” specifically invokes the means-plus-function claims limitation recited in 35 U.S.C. § 112(f) and such claim shall be construed to cover the corresponding structure, material, or acts described in the specification and equivalents thereof.
The phrase “MEANS FOR” specifically invokes the means-plus-function claims limitation recited in 35 U.S.C. § 112(f) and such claim shall be construed to cover the corresponding structure, material, or acts described in the specification and equivalents thereof.
The phrase “STEP FOR” specifically invokes the step-plus-function claims limitation recited in 35 U.S.C. § 112(f) and such claim shall be construed to cover the corresponding structure, material, or acts described in the specification and equivalents thereof.
The step-plus-function claims limitation recited in 35 U.S.C. § 112(f) shall be construed to cover the corresponding structure, material, or acts described in the specification and equivalents thereof ONLY for such claims including the phrases “MEANS FOR”, “MEANS”, or “STEP FOR”.
The phrase “AND/OR” in the context of an expression “X and/or Y” should be interpreted to define the set of “(X and Y)” in union with the set “(X or Y)” as interpreted by Ex Parte Gross (USPTO Patent Trial and Appeal Board, Appeal 2011-004811, Ser. No. 11/565,411, (“‘and/or’ covers embodiments having element A alone, B alone, or elements A and B taken together”).
The claims presented herein are to be interpreted in light of the specification and drawings presented herein with sufficiently narrow scope such as to not preempt any abstract idea.
The claims presented herein are to be interpreted in light of the specification and drawings presented herein with sufficiently narrow scope such as to not preclude every application of any idea.
The claims presented herein are to be interpreted in light of the specification and drawings presented herein with sufficiently narrow scope such as to preclude any basic mental process that could be performed entirely in the human mind.
The claims presented herein are to be interpreted in light of the specification and drawings presented herein with sufficiently narrow scope such as to preclude any process that could be performed entirely by human manual effort.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A series tailored a thermally stabilized optical (STASO) telescope system (STASOS) comprising:
(a) optical mirror source (OMS);
(b) optical focal target (OFT);
(c) first metering rod (FMR);
(d) second metering rod (SMR); and
(e) third metering rod (TMR);
wherein:
said OMS comprises a mirror reference surface (MRS) perpendicular to an optical axis of said OMS;
said OFT comprises a focal reference plane (FRP) aligned to an optical axis of said OFT;
said FMR, said SMR and said TMR each comprise a first retaining rod (FRR) comprised of a material having a first thermal expansion (FTE) coefficient;
said FMR, said SMR and said TMR each comprise a second retaining rod (SRR) comprised of a material having a second thermal expansion (STE) coefficient;
said FMR, said SMR and said TMR are aligned parallel to said optical axis of said OMS;
said FMR, said SMR and said TMR are configured to align said OMS and OFT along a common optical axis (COA);
said FMR, said SMR and said TMR are configured to separate said OMS and said OFT along said COA and define a predetermined focal distance (PFD) between said MRS and said FRP;
said FRR is constructed from a thermalized metallic material (TMM) selected to produce in combination with said SRR a thermally neutral or controlled optical (TNO) variation in said PFD;
said TMM is constructed by deforming a metallic material by applying tension in a first direction;
said TMM, subsequent to said deformation, exhibits a first thermal expansion characteristic having a coefficient of thermal expansion within a predetermined range;
said coefficient of thermal expansion is in at least said first direction; and
said TMM, subsequent to said deformation, exhibits a second thermal expansion characteristic in a second direction; and
wherein said TMM comprises a material selected from a group consisting of:
(1) a material characterized by a general formula Ti_{100-A}X_{A}, wherein X is at least one of Ni, Nb, Mo, Ta, Pd, Pt, or combinations thereof, and A is in a range from 0 to 75 atomic percent composition;
(2) a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
(3) a material characterized by a general formula Ti_{100-A-B}Nb_{A}X_{B}, wherein X is at least one of Al, Sn, Ta, Hf, Zr, Al, Au, Pt, Fe, Co, Cr, Mo, V, 0, or combinations thereof, and A is in a range from 0 to 55 atomic percent composition, and B is in a range from 0 to 75 atomic percent composition such that A plus B is less than 100; and
(4) a material characterized by a general formula Ti_{100-A-B}Ta_{A}X_{B}, wherein X is at least one of Al, Sn, Nb, Zr, Mo, Al, Au, Pt, Fe, Co, Cr, Hf, V, 0, or combinations thereof, and A is in a range from 0 to 55 atomic percent composition, and B is in a range from 0 to 75 atomic percent composition such that A plus B is less than 100.

2. The system of claim 1 wherein said deformation is achieved by at least one of:
(1) hot-rolling;
(2) cold-rolling;
(3) plane strain compression;
(4) bi-axial tension;
(5) conform processing;
(6) bending;
(7) drawing;
(8) wire-drawing;
(9) swaging;
(10) extrusion;
(11) equal channel angular extrusion;
(12) precipitation heat treatment under stress;
(13) annealing;
(14) sintering;
(15) monotonic tension processing;
(16) monotonic compression processing;
(17) monotonic torsion processing;
(18) cyclic thermal training under stress; and
(19) combinations thereof.

3. The system of claim 1 wherein said predetermined range of said coefficient of thermal expansion ranges from −150×10⁻⁶K⁻¹ to +500×10⁻⁶K⁻¹.

4. The system of claim 1 wherein said deforming of said metallic material further comprises texturing said metallic material in a direction comprising at least one of a [111], a [100], or a [001] direction.

5. The system of claim 1 wherein said TMM comprises a material having a negative thermal expansion (NTE) coefficient.

6. The system of claim 1 wherein:
said deforming said TMM comprises applying tension in at least one direction; and
said second thermal expansion characteristic subsequent to said deformation is in at least one direction.

7. The system of claim 1 wherein:
said deforming said TMM comprises applying compression in first direction;
said second thermal expansion characteristic subsequent to said deformation is in at least one predetermined direction; and
said at least one predetermined direction is perpendicular to said first direction.

8. The system of claim 1 wherein:
said deforming said TMM comprises applying shear in said first direction;
said second thermal expansion characteristic subsequent to deformation is in at least one predetermined direction; and
said at least one predetermined direction is 45° to said first direction.

9. The system of claim 1 wherein:
said FMR, said SMR, and said TMR are each comprised of tubular elements defined by multiple said FRR and said SRR elements configured into an optical telescope assembly (OTA);
said FRR and said SRR axes of said STASOS in said OTA are aligned parallel to the optical axis of said OMS;
said OTA is axially symmetric along the optical axis of said OMS;
said OTA is configured to attached directly or indirectly to said OMS; and
said OTA is configured to separate said OMS and said OFT along said COA and define a predetermined distance between said MRS and said FRP.

10. The system of claim 1 wherein:
said PFD is defined by multiple said STASOS elements configured into an optical telescope assembly (OTA);
said FRR and said SRR axes of said STASOS in said OTA are aligned at a pre-determined angle to the optical axis of said OMS;
said OTA is axially symmetric along the optical axis of said OMS;
said OTA is configured to attached directly or indirectly to said OMS; and
said OTA is configured to separate said OMS and said OFT along said COA and define a predetermined distance between said MRS and said FRP.

11. The system of claim 1 wherein:
said PFD is defined by multiple said STASOS elements configured into an optical telescope assembly (OTA);
said FRR and said SRR axes of said STASOS in said OTA are aligned parallel to the optical axis of said OMS;
said OTA is not axially symmetric along and off-axis to the optical axis of said OMS;
said OTA is configured to attached directly or indirectly to said OMS; and
said OTA is configured to separate said OMS and said OFT along said COA and define a predetermined distance between said MRS and said FRP.

12. The system of claim 1 wherein:
said PFD is defined by multiple said STASOS elements configured into an optical telescope assembly (OTA);
said FRR and said SRR axes of said STASOS in said OTA are aligned at a pre-determined angle to the optical axis of said OMS;
said OTA is not axially symmetric along and off-axis to the optical axis of said OMS;
said OTA is configured to attached directly or indirectly to said OMS; and
said OTA is configured to separate said OMS and said OFT along said COA and define a predetermined distance between said MRS and said FRP.

13. A series tailored a thermally stabilized optical (STASO) method (STASOM) comprising:
separating an optical mirror source (OMS) and an optical focal target (OFT) via a first metering rod (FMR), second metering rod (SMR), and third metering rod (TMR) wherein said FMR, said SMR, and said TMR each comprise a first retaining rod (FRR) and a second retaining rod (SRR);
configuring said OMS and said OFT along a common optical axis (COA);
configuring said FMR, said SMR, and said TMR parallel to said COA; and
configuring said FRRs and said SRRs to separate said OMS and OFT along said COA and define a predetermined focal distance (PFD) between a mirror reference plane (MRS) perpendicular to an optical axis of said OMS and a focal reference plane (FRP) aligned to an optical axis of said OFT;
wherein:
said FRR comprises a material having a first thermal expansion (FTE) coefficient;
said SRR comprises of a material having a second thermal expansion (STE) coefficient;
said FRR is constructed from a thermalized metallic material (TMM) selected to produce in combination with said SRR a thermally neutral or controlled optical (TNO) variation in said PFD;
said TMM is constructed by deforming a metallic material by applying tension in a first direction;
said TMM, subsequent to said deformation, exhibits a first thermal expansion characteristic having a coefficient of thermal expansion within a predetermined range;
said coefficient of thermal expansion is in at least said first direction; and
said TMM, subsequent to said deformation, exhibits a second thermal expansion characteristic in a second direction; and
wherein said TMM comprises a material selected from a group consisting of:
a material characterized by a general formula Ti_{100-A}X_{A}, wherein X is at least one of Ni, Nb, Mo, Ta, Pd, Pt, or combinations thereof, and A is in a range from 0 to 75 atomic percent composition;
a material characterized by a general formula Ti_{100-A-B}Ni_{A}X_{B}, wherein X is at least one of Pd, Hf, Zr, Al, Pt, Au, Fe, Co, Cr, Mo, V, O or combinations thereof, and A is in a range from 0 to 55 atomic percent composition, and B is in a range from 0 to 75 atomic percent composition such that A plus B is less than 100;
a material characterized by a general formula Ti_{100-A-B}Nb_{A}X_{B}, wherein X is at least one of Al, Sn, Ta, Hf, Zr, Al, Au, Pt, Fe, Co, Cr, Mo, V, 0, or combinations thereof, and A is in a range from 0 to 55 atomic percent composition, and B is in a range from 0 to 75 atomic percent composition such that A plus B is less than 100; and
a material characterized by a general formula Ti_{100-A-B}Ta_{A}X_{B}, wherein X is at least one of Al, Sn, Nb, Zr, Mo, Al, Au, Pt, Fe, Co, Cr, Hf, V, 0, or combinations thereof, and A is in a range from 0 to 55 atomic percent composition, and B is in a range from 0 to 75 atomic percent composition such that A plus B is less than 100.

14. The method of claim 13 wherein said deforming is achieved by at least one of:
(1) hot-rolling;
(2) cold-rolling;
(3) plane strain compression;
(4) bi-axial tension;
(5) conform processing;
(6) bending;
(7) drawing;
(8) wire-drawing;
(9) swaging;
(10) extrusion;
(11) equal channel angular extrusion;
(12) precipitation heat treatment under stress;
(13) annealing;
(14) sintering;
(15) monotonic tension processing;
(16) monotonic compression processing;
(17) monotonic torsion processing;
(18) cyclic thermal training under stress; and
(19) combinations thereof.

15. The method of claim 13 wherein said predetermined range of said coefficient of thermal expansion ranges from −150×10⁻⁶K⁻¹ to +500×10⁻⁶K⁻¹.

16. The method of claim 13 wherein said deforming of said TMM further comprises texturing said metallic material in a direction comprising at least one of a [111], a [100], or a [001] direction.

17. The method of claim 13 wherein said FRR comprises a material having a negative thermal expansion (NTE) coefficient.

18. The method of claim 13 wherein the sum of said FTE coefficient and said STE coefficient is zero.

19. The method of claim 13 wherein:
said deforming said TMM comprises applying tension in at least one direction; and
said second thermal expansion characteristic subsequent to said deformation is in at least one direction.

20. The method of claim 13 wherein:
said deforming said TMM comprises applying compression in said first direction;
said second thermal expansion characteristic subsequent to said deformation is in at least one predetermined direction; and
said at least one predetermined direction is perpendicular to said first direction.

21. The method of claim 13 wherein:
said deforming said TMM comprises applying shear in said first direction;
said second thermal expansion characteristic subsequent to deformation is in at least one predetermined direction; and
said at least one predetermined direction is 45° to said first direction.

22. The method of claim 13 wherein:
said PFD is defined by multiple said STASOS elements configured into an optical telescope assembly (OTA);
said FRR and said SRR axes of said STASOS in said OTA are aligned parallel to the optical axis of said OM;
said OTA is axially symmetric along the optical axis of said OM;
said OTA is configured to attached directly or indirectly to said OM, and
said OTA is configured to separate said OMS and said OFT along said COA and define a predetermined distance between said MRS and said FRP.

23. The method of claim 13 wherein:
said PFD is defined by multiple said STASOS elements configured into an optical telescope assembly (OTA);
said FRR and said SRR axes of said STASOS in said OTA are aligned at a pre-determined angle to the optical axis of said OM;
said OTA is axially symmetric along the optical axis of said OM;
said OTA is configured to attached directly or indirectly to said OM; and
said OTA is configured to separate said OMS and said OFT along said COA and define a predetermined distance between said MRS and said FRP.

24. The method of claim 13 wherein:
said PFD is defined by multiple said STASOS elements configured into an optical telescope assembly (OTA);
said FRR and said SRR axes of said STASOS in said OTA are aligned parallel to the optical axis of said OM;
said OTA is not axially symmetric along and off-axis to the optical axis of said OM;
said OTA is configured to attached directly or indirectly to said OM; and
said OTA is configured to separate said OMS and said OFT along said COA and define a predetermined distance between said MRS and said FRP.

25. The method of claim 13 wherein:
said PFD is defined by multiple said STASOS elements configured into an optical telescope assembly (OTA);
said FRR and said SRR axes of said STASOS in said OTA are aligned at a pre-determined angle to the optical axis of said OM;
said OTA is not axially symmetric along and off-axis to the optical axis of said OM;
said OTA is configured to attached directly or indirectly to said OM; and
said OTA is configured to separate said OMS and said OFT along said COA and define a predetermined distance between said MRS and said FRP.
